(19) United States
(12) Patent Application Publication
(10) Pub. No.: US 2026/0068869 A1
(43) Pub. Date: Mar. 12, 2026

(54) ROBOTIC MODULAR SYSTEM FOR REMOVING VEGETATION

(71) Applicant: INVASIVE REMOVAL LLC, Ames, IA (US)

(72) Inventors: Mark Vande Haar, Ames, IA (US); Dewayne Higgs, Armarillo, TX (US)

(21) Appl. No.: 19/320,585

(22) Filed: Sep. 5, 2025

Related U.S. Application Data
(60) Provisional application No. 63/692,333, filed on Sep. 9, 2024.

(51) Int. Cl. A01M 21/02; A01M 7/00; A01M 21/04

(52) U.S. Cl. CPC A01M 21/02; A01M 7/0089; A01M 21/043; A01M 21/046

(57) ABSTRACT

In one or more illustrative arrangements, a robotic modular system is presented that is configured to remove vegetation, which may be an invasive plant species and/or target plant. In one or more illustrative arrangements, the robotic modular system includes a cutting module, a spraying module, and an optical module. In one or more illustrative arrangements, the system identifies an invasive species and/or target plant, the system is then moved near the invasive species and/or target plant, and the cutting module is positioned to perform a cutting operation. In one or more illustrative arrangements, the cutting module then performs a cutting operation on the invasive species and/or target plants, and the spraying module sprays the remaining portion thereof.

### CROSS REFERENCE TO RELATED PATENT APPLICATIONS

This application claims priority to U.S. Provisional Patent Application No. 63/692,333, titled “ROBOTIC MODULAR SYSTEM FOR REMOVING INVASIVE SPECIES” filed on Sep. 9, 2024, the entirety of which is incorporated by reference herein.

### FIELD OF THE DISCLOSURE

This disclosure relates to a robotic modular system. More specifically, this disclosure relates to a robotic modular system configured to remove vegetation and/or target plants, which vegetation may be invasive plant species.

### OVERVIEW OF THE DISCLOSURE

Invasive plant species (or simply “invasive species” or “vegetative invasive species”) as used herein) can be destructive to native plant species, but invasive plant species can be difficult to identify, maintain, and eradicate among other challenges. Various techniques have been used to attempt to eradicate invasive plant species, including cutting invasive species using an axe, hatchet, machete, saw blade, chain saw, shears, plasma cutter, laser cutter, or any other type or configuration of cutter. Another method that has been used is spraying invasive species with various solutions including herbicides. However, even with these methods it is difficult to reach these invasive species and/or target plants in dense forests or wooded areas with many different plant species, and it may be difficult to identify such invasive species and/or target plants. Additionally, it is often difficult, time-consuming, unsafe, laborious, and/or otherwise not feasible for a human to perform these tasks in an efficient and continuous manner due to weather conditions, ground conditions, and/or the physical toll of having to (in many circumstances) bend down to identify invasive species and/or target plants, perform cuts on the invasive species and/or target plants, accurately spray the invasive species and/or target plants, and/or otherwise treat the invasive species and/or target plants.

Therefore, for all the reasons stated above, and the reasons stated below, there is a need in the art for an improved system for removing invasive species and/or target plants. Thus, it is a primary objective of the disclosure to provide a robotic modular system for removing invasive species and/or target plants that improves upon the state of the art.

Another objective of the disclosure is to provide a robotic modular system for removing invasive species and/or target plants that is capable of navigating in various types of terrains.

Yet another objective of the disclosure is to provide a robotic modular system for removing invasive species and/or target plants that is capable of traversing various obstacles.

Another objective of the disclosure is to provide a robotic modular system for removing invasive species and/or target plants that is safe to operate.

Yet another objective of the disclosure is to provide a robotic modular system for removing invasive species and/or target plants that is relatively easy to build.

Another objective of the disclosure is to provide a robotic modular system for removing invasive species and/or target plants that is relatively friendly to build.

Yet another objective of the disclosure is to provide a robotic modular system for removing invasive species and/or target plants that can be built relatively quickly and efficiently.

Another objective of the disclosure is to provide a robotic modular system for removing invasive species and/or target plants that is easy to operate.

Yet another objective of the disclosure is to provide a robotic modular system for removing invasive species and/or target plants that is relatively cost friendly to manufacture.

Another objective of the disclosure is to provide a robotic modular system for removing invasive species and/or target plants that is relatively easy to transport.

Yet another objective of the disclosure is to provide a robotic modular system for removing invasive species and/or target plants that is aesthetically appealing.

Another objective of the disclosure is to provide a robotic modular system for removing invasive species and/or target plants that is robust.

Another objective of the disclosure is to provide a robotic modular system for removing invasive species and/or target plants that is relatively inexpensive.

Yet another objective of the disclosure is to provide a robotic modular system for removing invasive species and/or target plants that is not easily susceptible to wear and tear.

Another objective of the disclosure is to provide a robotic modular system for removing invasive species and/or target plants that has a long useful life.

Yet another objective of the disclosure is to provide a robotic modular system for removing invasive species and/or target plants that is efficient to use and operate.

These and other objects, features, or advantages of the disclosure will become apparent from the specification, figures, and claims.

### SUMMARY OF THE DISCLOSURE

In one or more illustrative arrangements, a robotic modular system is presented that is configured to remove invasive species and/or target plants. In one or more illustrative arrangements, the robotic modular system includes a cutting module, a spraying module, and an optical module. In one or more illustrative arrangements, the system identifies an invasive species and/or target plants, the system is then moved near the invasive species and/or target plant and the cutting module is positioned to perform a cutting operation. In one or more illustrative arrangements, the cutting module then performs a cutting operation on the invasive species and/or target plants and the spraying module sprays the remains/remaining portion of the invasive species and/or target plants. However, other arrangements and/or embodiments of the robotic modular system may be differently configured and/or designed for other applications without limitation unless otherwise indicated in the following claims.

### BRIEF DESCRIPTION OF THE FIGURES

FIG. 1 provides a perspective view of an illustrative arrangement of a robotic modular system and a schematic diagram of an illustrative embodiment of an identification system that may be in communication with the robotic modular system.

FIG. 2 provides a perspective view of an illustrative arrangement of a robotic modular system and a schematic diagram of an illustrative embodiment of a positioning system that may be in communication with the robotic modular system.

FIG. 3 provides a back-end view of the illustrative arrangement of a robotic modular system shown in FIGS. 1 & 2.

FIG. 4 provides a perspective view of the illustrative arrangement of a robotic modular system shown in FIGS. 1 & 2.

FIG. 5 provides a front-end view of the illustrative arrangement of a robotic modular system shown in FIGS. 1 & 2.

FIG. 6 provides a side view of the illustrative arrangement of a robotic modular system shown in FIGS. 1 & G2.

FIG. 7 is a flow chart of a process for operating an illustrative arrangement of a robotic modular system with a relatively high amount of user involvement.

FIG. 8 is a flow chart of a process for operating an illustrative arrangement of a robotic modular system with a relatively high amount of user involvement through a mobile application.

FIG. 9 is a flow chart of a process for operating an illustrative arrangement of a robotic modular system with a relatively lower amount of user involvement (wherein the robotic modular system may be semi-autonomous) through a mobile application, and which process may be used to train the robotic modular system to identify invasive species and/or target plants.

FIG. 10 is a flow chart of a process for operating an illustrative arrangement of a robotic modular system with a minimal amount to no amount of user involvement (wherein the robotic modular system may be fully autonomous), and which process may be used to further train and refine the robotic modular system's ability to identify invasive species and/or target plants.

### DETAILED DESCRIPTION OF THE DISCLOSURE

In the following detailed description of the embodiments, reference is made to the accompanying drawings which form a part hereof, and in which is shown by way of illustration specific and illustrative embodiments in which the disclosure may be practiced. The embodiments of the present disclosure described herein and below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the present disclosure. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any specific advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the illustrative embodiments that may be described herein. The contemplated embodiments are not so limited and should not be interpreted as being restricted to embodiments that address such objects of the disclosure or illustrative embodiments. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure without limitation unless otherwise indicated in the following claims.

It is to be understood that the terms such as “left,” “right,” “top,” “bottom,” “front,” “back,” “side,” “height,” “length,” “width,” “upper,” “lower,” “interior,” “exterior,” “inner,” “outer,” and the like as may be used herein, and merely describe points of reference and do not limit the present disclosure to any particular orientation or configuration unless otherwise indicated in the following claims.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously introduced and not, while definite articles like “the” refer to a same previously introduced term; as such, it is understood that “a” or “an” modify items that are permitted to be previously introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively” or “operably,” such as when used as “operatively connected” or “operably engaged” is to be interpreted as connected or engaged, respectively, in any manner that facilitates operation, which may include being directly connected, indirectly connected, electronically connected, wirelessly connected, or connected by any other manner, method, or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed illustrative embodiments and arrangements may be primarily described in the context of removing vegetative invasive species and/or target plants. However, the scope of the present disclosure is not so limited, and it will be appreciated by those skilled in the art that the illustrative embodiments may be adapted for use in other applications that may be improved by the disclosed structures, arrangements, and/or methods. The system is merely shown and described as being used in in the context of removing invasive species and/or target plants for ease of description and as one of countless examples and may extend to other applications without limitation unless otherwise indicated in the following claims.

Robotic Modular System for Removing Invasive Species and/or Target Plants

With reference to the figures, a robotic modular system 10 (or simply “system 10”) for removing vegetation is presented. System 10 is formed of any suitable size, shape, and design without limitation unless otherwise indicated in the following claims and in an illustrative arrangement is configured to cut and spray invasive plant species and/or target plants in order to eradicate invasive species and/or target plants. In the illustrative arrangement shown, as one example, system 10 has a forward end 12, a rearward end 14, opposing left and right sides 16 (or simply “sides 16”), a top side 18, and a bottom side 20. In the illustrative arrangement shown, as one example, system 10 includes a body 22, a drive system 24, an optical module 26, a cutting module 28, a spraying module 30, a positioning system 32, a control assembly 34, and a power source 36, among other components as are described herein.

In the illustrative arrangement shown, as one example, system 10 is configured to operate in various types of terrains including prairies, wooded areas, forested areas, or any other terrain, environment, or setting without limitation unless otherwise indicated in the following claims. In one or more illustrative arrangements, system 10 may be operated by a user such as by a remote control or a mobile application, system 10 may be operated semi-autonomously (with some actions performed autonomously and some actions being prompted by a user such as by a remote control or mobile application), or system 10 may be operated autonomously.

In the illustrative arrangement shown, as one example, system 10 uses both a cutting method and a squirting method to remove invasive species and/or target plants. That is, in the illustrative arrangement shown, as one example, system 10 will (or will be used to) identify the invasive species and/or target plants, cut the invasive species and/or target plants, and then spray herbicides or other solutions onto the remains of the invasive species and/or target plant in order to eradicate it.

While system 10 has been described according to the illustrative arrangement shown, as one example, any combination or arrangement may be used and is hereby contemplated for use without limitation to the particular application of the system 10 unless otherwise indicated in the following claims.

### Body 22:

In the illustrative arrangement shown, as one example, system 10 includes a body 22. Body 22 is formed of any suitable size, shape, and design and is configured to operably connect/engage the various components of system 10, house various components of system 10, provide stability and rigidity to system 10, and/or for any other purpose or functionality without limitation unless otherwise indicated in the following claims. In the illustrative arrangement shown, as one example, body 22 includes a front member 40, left and right side members 42 (or simply “side members 42”), a rear member 44, a first top section 46, a second top section 48, and bottom member 50.

In the illustrative arrangement shown, as one example, when viewed from either side 16 of system 10, body 22 is a generally rectangular member with a bottom member 50 extending in approximate parallel spaced relation to each of first top section 46 and second top section 48 and in approximate perpendicular relation to front member 40 and rear member 44. In the illustrative arrangement shown, as one example, when viewed from forward end 12 of system 10, body 22 is a generally rectangular member with first top section 46 extending in approximate parallel spaced relation to bottom member 50 and in approximate perpendicular spaced relation to each side member 42. In the arrangement shown, as one example, when viewed from rearward end 14 of system 10, body 22 is a generally rectangular member with second top section 48 extending in approximate parallel spaced relation to bottom member 50 and in approximate perpendicular relation to each side member 42. In the illustrative arrangement shown, as one example, when viewed from top side 18 or bottom side 20, body 22 is a generally rectangular member with front member 40 extending in approximate parallel spaced relation to rear member 44 and in approximate perpendicular relation to each side member 42.

In the illustrative arrangement shown, as one example, body 22 is formed of multiple pieces that are connected or assembled to one another through bolting, however any other means of or apparatus for connecting or assembling the multiple pieces may be used, including screwing, welding, friction fitting, or the like. Alternatively, body 22 may be formed of a single, unitary member that is formed in a manufacturing process such as machining, forming, additive manufacturing, casting, or the like to form a unitary and monolithic member. Accordingly, the scope of the present disclosure is not limited to the specific manufacturing process and/or method used to construct body 22 and/or components thereof but extends to all known or later-developed manufacturing processes and/or methods without limitation unless otherwise indicated in the following claims.

In the arrangement shown, as one example, body 22 is formed primarily of a metallic material such as steel, aluminum, chromium, or any other metallic material, alloy, composite thereof, and/or combinations thereof. Alternatively, body 22 may be formed of a non-metallic material such as a plastic material, a fiberglass material, or any other suitable non-metallic material and/or composite thereof currently know or later developed. Accordingly, the material of construction of body 22 and/or components thereof is in no way limiting to the scope of the present disclosure and any suitable material currently known or later developed may be used unless otherwise indicated in the following claims.

In the illustrative arrangement shown, as one example, body 22 includes a front member 40 and a rear member 44. Front member 40 and rear member 44 are formed of any suitable size, shape, and design and are configured to help enclose various components of system 10 and provide stability and rigidity to system 10, and/or to provide other advantages/functions without limitation unless otherwise indicated in the following claims. In the illustrative arrangement shown, as one example, front member 40 is configured to operably connect to each side member 42, first top section 46, and bottom member 50. In the arrangement shown, as one example, rear member 44 is configured to operably connect to each side member 42, second top section 48, and bottom member 50.

In the illustrative arrangement shown, as one example, body 22 includes a first top section 46 and a second top section 48. First top section 46 and second top section 48 are formed of any suitable size, shape, and design and are configured to support various components of system 10 and help enclose various components of system 10, and/or to provide other advantages/functions without limitation unless otherwise indicated in the following claims. In the arrangement shown, as one example, first top section 46 is configured to operably connect to each side member 42, as well as front member 40 and second top section 48. In the illustrative arrangement shown, as one example, second top section 48 is configured to connect to each side member 42 as well as rear member 44 and first top section 46.

In the illustrative arrangement shown, as one example, first top section 46 is configured to operably connect to/engage with and support optical module 26. More specifically, in the illustrative arrangement shown, as one example, first top section 46 is configured to operably connect to track 60 of optical module 26 in order for optical module 26 to move across body 22 from near one side 16 of system 10 to near the other side 16 of system 10.

In the illustrative arrangement shown, as one example, first top section 46 is positioned such that the top surface of first top section 46 is positioned below the top surface of second top section 48. In this illustrative arrangement, as one example, body 22 may provide additional height to arm 108 of cutting module 28 while allowing arm 108 of cutting module 28 to tilt and/or move downwards when needed in order to cut invasive species and/or target plants.

In another illustrative arrangement, various sensors and/or other components (e.g., lights, antennas, etc.) may be positioned on the top surface of the first top section 46 or second top section 48 without limitation unless otherwise indicated in the following claims. In still other illustrative arrangements of a system 10, lights may be positioned on other components of system 10 (e.g., front member 40, side members 42, rear member 44, optical module 26, cutting module 28, spraying module 30, etc.) and may be activated automatically or by a user without limitation unless otherwise indicated in the following claims.

In the illustrative arrangement shown, as one example, second top section 48 is configured to operably connect to/engage with and support the rotating member 102 of arm assembly 94 of cutting module 28. In the illustrative arrangement shown, as one example, rotating member 102 of arm assembly 94 of cutting module 28 is configured to rest on top of and operably connect to/engage with second top section 48 in a manner which allows rotating member 102 of arm assembly 94 of cutting module 28 to rotate in order to move cutting member 100 of cutting module 28 from side to side.

In the illustrative arrangement shown, as one example, body 22 includes bottom member 50. Bottom member 50 is formed of any suitable size, shape, and design and is configured to help enclose various components of system 10 and provide stability and rigidity to system 10, and/or to provide other advantages/functions without limitation unless otherwise indicated in the following claims. In the illustrative arrangement shown, as one example, bottom member 50 is configured to operably connect to each side member 42, front member 40, and rear member 44.

In the illustrative arrangement shown, as one example, body 22 includes side members 42. Side members 42 are formed of any suitable size, shape, and design and are configured to help enclose various components of system 10, provide stability and rigidity to system 10, operably connect to/engage with drive system 24 of system 10, and/or to provide other advantages/functions without limitation unless otherwise indicated in the following claims. In the illustrative arrangement shown, as one example, each side member 42 is configured to engage front member 40, rear member 44, first top section 46, second top section 48, and bottom member 50 in a secure manner.

In the illustrative arrangement shown, as one example, side member 42 is configured to operably connect to/engage with drive system 24. In the illustrative arrangement shown, as one example, each side member 42 includes openings (not shown) therethrough near the forward end 12 and rearward end 14 of system 10. In the illustrative arrangement shown, as one example, the openings of side members 42 allow axles (not shown) of drive system 24 to extend through each side member 42 such that a portion of the axles of drive system 24 rest outside of body 22 on both sides 16 of system 10 at or near both forward end 12 and rearward end 14 of system 10.

While body 22 and its various components and features have been described according the illustrative arrangement shown, as one example, it will be understood by those skilled in the art that any other configuration of body 22 and its various components may be used in order to operably connect to/engage with the various components of system 10, house various components of system 10, provide stability and rigidity to system 10, and/or to provide other advantages/functions without limitation unless otherwise indicated in the following claims.

### Drive System 24:

In the illustrative arrangement shown, as one example, system 10 includes drive system 24. Drive system 24 is formed of any suitable size, shape, and design and is configured to allow system 10 to be driven around various terrains. In the illustrative arrangement shown, as one example, drive system 24 includes a motor (not shown), axles (not shown), and wheels 54. In the illustrative arrangement, drive system 24 generally is configured to provide motive power and directionality of that motive power to system 10.

### Motor:

In the illustrative arrangement shown, as one example, drive system 24 includes a motor (not shown). The motor of drive system 24 is formed of any suitable size, shape, and design and is configured to operably connect to the axles of drive system 24 and ultimately facilitate movement of wheels 54. In the illustrative arrangement shown, as one example, the motor of drive system 24 is an electric motor, however any other type of motor, engine, or power source may be used in order to facilitate movement of wheels 54, such as a gas engine, a diesel engine, a solar energy source, a wind powered energy source, or any other source of energy or power without limitation unless otherwise indicated in the following claims.

### Axles:

In the illustrative arrangement shown, as one example, drive system 24 includes axles (not shown). The axles of drive system 24 are formed of any suitable size, shape, and design and are configured to operably connect to the motor of drive system 24 and to wheels 54, and transfer energy from the motor to wheels 54. In the illustrative arrangement shown, as one example, the axles operably connect to the motor of drive system 24 such that when the motor operates, the motor causes the axles to rotate. In the illustrative arrangement shown, as one example, the axles engage with wheels 54 in close and tight tolerances such that when the axles rotate, the wheels 54 also rotate, thereby causing system 10 to move. In the illustrative arrangement shown, as one example, there are two axles which connect to wheels 54 at each end of each axle. However, in various alternative arrangements, any number of axles may be used in drive system 24 and any number of wheels 54 may be placed on either end of the axles of drive system 24. Furthermore, in still other illustrative arrangements of a drive system 24, axles may not be required, and instead a motor (not shown) may be operably engaged with two or more individual wheels 54 via any suitable engagement configuration (e.g., chain, gear, shaft, etc.) without limitation unless otherwise indicated in the following claims.

### Wheels 54:

In the illustrative arrangement shown, as one example, drive system 24 includes wheels 54. Wheels 54 are formed of any suitable size, shape, and design and are configured to facilitate movement of system 10. Wheels 54 may be formed of any type of wheel and may include any combination of components included in wheels used in the art. Additionally, wheels 54 function in the same way as those wheels known to those of skill in the art. In the illustrative arrangement shown, as one example, a wheel 54 is connected to the opposing ends of each axle of drive system 24. In the illustrative arrangement shown, as one example, with two axles, there are four wheels 54, one at each of the opposing ends of each axle. In various alternative arrangements, any other number of wheels 54 may be used and any number of wheels 54 may be connected to the opposing ends of the axles of drive system 24 in order for system 10 to effectively move.

In another illustrative arrangement not pictured herein, drive system 24 may be configured with three wheels 54 along each of right and left side members 42 for a total of six wheels. Each wheel 54 may be configured with an independent suspension system (not shown) to allow relative motion between wheel 54 and certain portions of system 10, a dedicated motor (not shown) to provide rotational energy to wheel 54, and an encoder (not shown) to facilitate the movement of system 10 through the environment in which it is employed (wooded area, brush, etc.). Alternatively, one or more wheels 54 on each side member 42 (as opposed to each wheel 54) may be configured with independent suspension, a dedicated motor, and an encoder and additional wheels 54 may simply coast and provide physical support and/or stability to system 10.

In yet another illustrative arrangement not pictured herein, system 10 may be configured with a drive system 24 configured as a rocker-bogie system, which may include a main rocker (not shown) engaged with either side member 42 such that each main rocker may rotate with respect to side member 42. The main rockers may be engaged with one another through a differential, and each main rocker may rotate in opposite directions to one another to maintain approximately equal wheel 54 contact with the terrain/surface on each side 16 of system 10 as system 10 traverses uneven terrain. A first end of each main rocker may include a wheel 54 and the second end of each main rocker may be engaged with a bogie such that each bogie may rotate with respect to the main rocker. Each end of the bogie may include a wheel 54 such that drive system 24 employs a total of six wheels 54 with three wheels 54 positioned along either side member 42. It is contemplated that a rocker-bogie system may be optimal for at least some applications of the system 10 as it allows all six wheels 54 to maintain contact with the terrain surface and body 22 will maintain the average pitch of both rockers even as system 10 traverses rugged and highly uneven terrain. Each wheel 54 in a rocker-bogie arrangement may be configured with a dedicated motor and encoder, such that the directionality, power, speed, and other parameters may be adjusted independently for each wheel 54 in drive system 24 to enhance the mobility and maneuverability of system 10 while simultaneously mitigating the likelihood of system 10 becoming stuck, inoperable, or otherwise unable to achieve the desired operational outcome of system 10. Alternatively, one or more wheels 54 along each side 16 of system 10 may be configured with a dedicated motor and encoder.

In another illustrative arrangement not pictured herein, drive system 24 may be configured with tracks (not shown). In such an arrangement, it is contemplated that each track may be configured with an independent motor (not shown) and may optionally be configured with an encoder (not shown) to facilitate the movement of system 10 through the environment in which it is employed (wooded area, brush, etc.). In such an arrangement, it is contemplated that drive system 24 would employ a tank steering or differential steering system to adequately maneuver through the applicable terrain.

While drive system 24 and its various components have been described according to the illustrative arrangement shown, as one example, it will be understood by those skilled in the art that any other configuration of drive system 24 and its various components may be used in order to allow system 10 to traverse various terrain and/or environments. The optimal configuration of drive system 24 and/or the components thereof may vary from one application of system 10 to the next and is therefore in no way limiting to the scope of the present disclosure unless otherwise indicated in the following claims.

It is contemplated that for most applications, while system 10 is traversing a specific terrain and/or environment, it is looking for and attempting to identify invasive species and/or target plants using optical module 26 as further described below, but without limitation unless otherwise indicated in the following claims.

### Optical Module 26:

In the illustrative arrangement shown, as one example, system 10 includes optical module 26. Optical module 26 is formed of any suitable size, shape, and design and is configured to capture images of vegetation/plants and identify invasive species and/or target plants in order for system 10 to eradicate the invasive species and/or target plants. In the illustrative arrangement shown, as one example, optical module 26 includes track 60, pole 62, camera 64, and identification system 66.

### Track 60:

In the illustrative arrangement shown, as one example, optical module 26 includes track 60. Track 60 is formed of any suitable size, shape, and design and is configured to allow optical module 26 to move along the width of system 10 from near one side 16 to near the other side 16 of system 10. In the illustrative arrangement shown, as one example, track 60 includes opposing ends 68, opposing sides 70, and channel 72.

In the illustrative arrangement shown, as one example, track 60 is a generally rectangular, elongated member that extends a length between opposing ends 68. In the illustrative arrangement shown, as one example, one opposing end 68 is near one of sides 16 of system 10 and the other opposing end 68 is near the other side 16 of system 10. In the illustrative arrangement shown, as one example, track 60 extends a width that is approximately equal to the distance between opposing sides 70.

In the illustrative arrangement shown, as one example, track 60 also includes a channel 72 between opposing sides 70. In the illustrative arrangement shown, as one example, channel 72 extends along the length of track 60 from one opposing end 68 to the other opposing end 68. In the illustrative arrangement shown, as one example, channel 72 is shaped and sized, to receive the engagement tab 76 of base 74 of pole 62 of optical module 26 therein and allow engagement tab 76 to travel along the length of channel 72.

### Pole 62:

In the illustrative arrangement shown, as one example, optical module 26 includes pole 62. Pole 62 is formed of any suitable size, shape, and design and is configured to move along the length of track 60 and allow camera 64 to be moved up and down along the height of pole 62. In the illustrative arrangement shown, as one example, pole 62 includes a base 74 with an engagement tab 76 and a rod 78.

In the illustrative arrangement shown, as one example, pole 62 includes base 74. Base 74 is formed of any suitable size, shape, and design and is configured to provide a stable and ridged base for pole 62, as well as operably engage pole 62 with track 60. In the illustrative arrangement shown, as one example, base 74 is a generally cylindrical member have a top side, a bottom side, and an exterior surface.

In the illustrative arrangement shown, as one example, base 74 includes an engagement tab 76 extending outward from the bottom side of base 74. Engagement tab 76 is formed of any suitable size, shape, and design and is configured to be inserted into channel 72 of track 60 and be operably held within channel 72 while also being allowed to slide along the length of channel 72.

In the illustrative arrangement shown, as one example, the rod 78 of pole 62 extends out of the top surface of base 74. Rod 78 is formed of any suitable size, shape, and design and is configured to allow camera 64 to slide up and down along the length of rod 78. In the illustrative arrangement shown, as one example, rod 78 is a generally cylindrical, elongated member which extends between a lower end and an upper end. In the illustrative arrangement shown, as one example, rod 78 also includes an exterior surface that is configured to be engaged by an attachment member on camera 64.

### Camera 64:

In the illustrative arrangement shown, as one example, optical module 26 includes a camera 64. Camera 64 is formed of any suitable size, shape, and design and is configured to capture images, either live video or still or both, of vegetation/plants in order to identify invasive species and/or target plants to eradicate. In the illustrative arrangement shown, as one example, camera 64 may be a GoPro® camera, or similar action camera, or camera 64 may be a still photo camera, or any other type of camera currently available or later developed that is suitable for the particular application of system 10, whether they be video cameras or still photo cameras, without limitation unless otherwise indicated int eh following claims.

In the illustrative arrangement shown, as one example, camera 64 also includes a connection member 80. Connection member 80 is formed of any suitable size, shape, and design and is configured to operably connect camera 64 to rod 78. In the illustrative arrangement shown, as one example, connection member 80 is a U-bracket that is shaped and sized to extend around rod 78 of pole 62 and engage rod 78 within close and tight tolerances such that camera 64 is frictionally engaged with rod 78 and does not move relative to rod 78 unless moved by a user along the rod 78 of pole 62.

In the illustrative arrangement shown, as one example, the images captured by camera 64 are analyzed using identification system 66 in order to identify invasive species and/or target plants as further described below for an illustrative application of system 10 but without limitation unless otherwise indicated in the following claims.

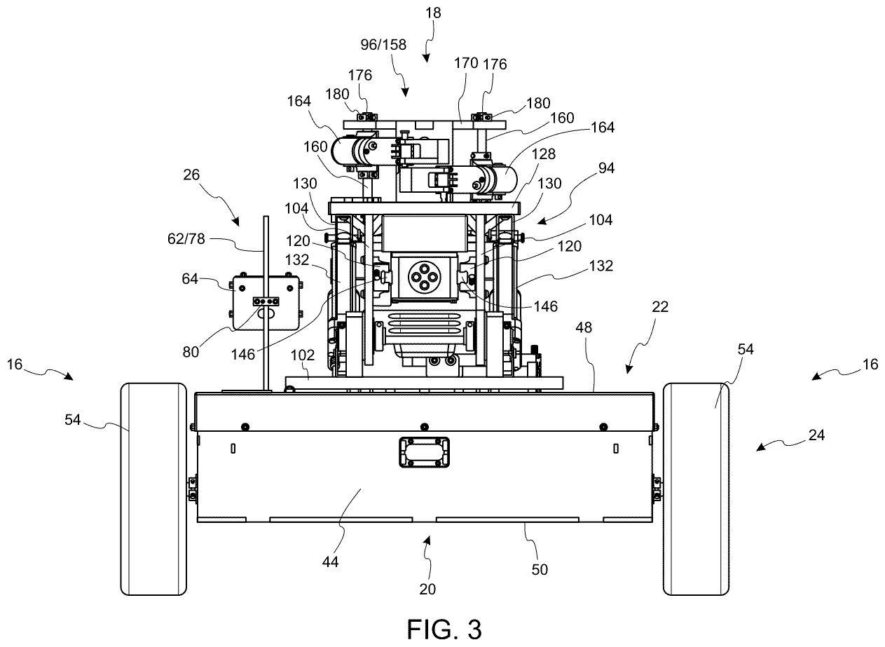

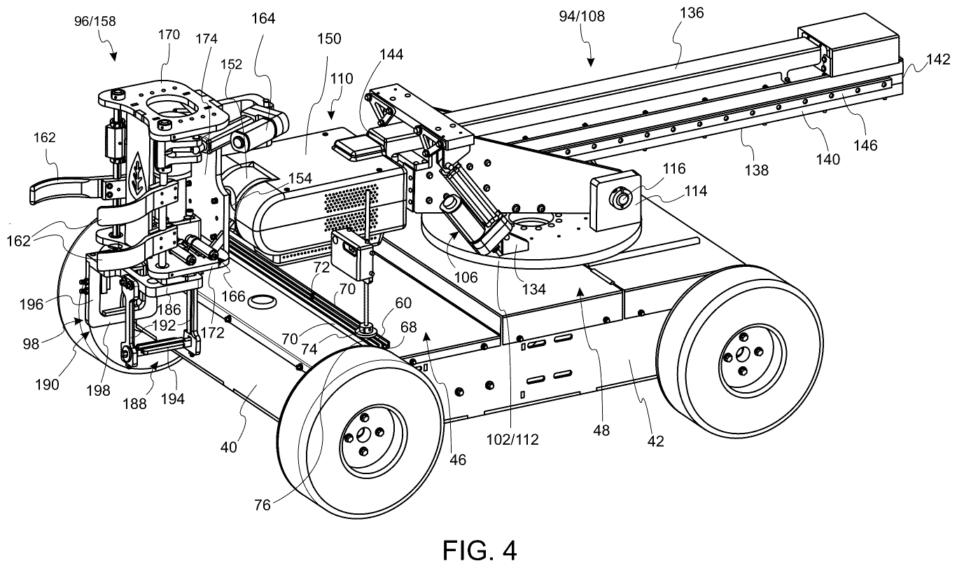

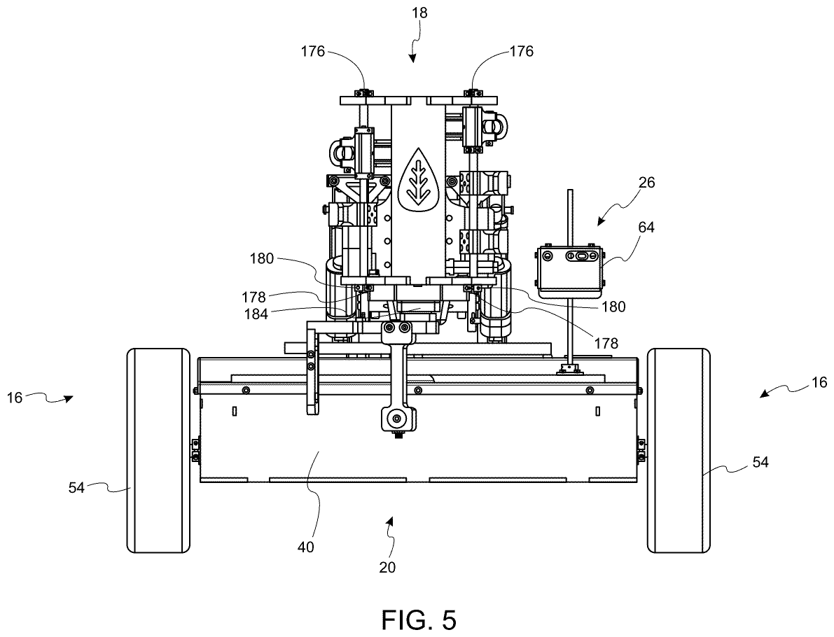

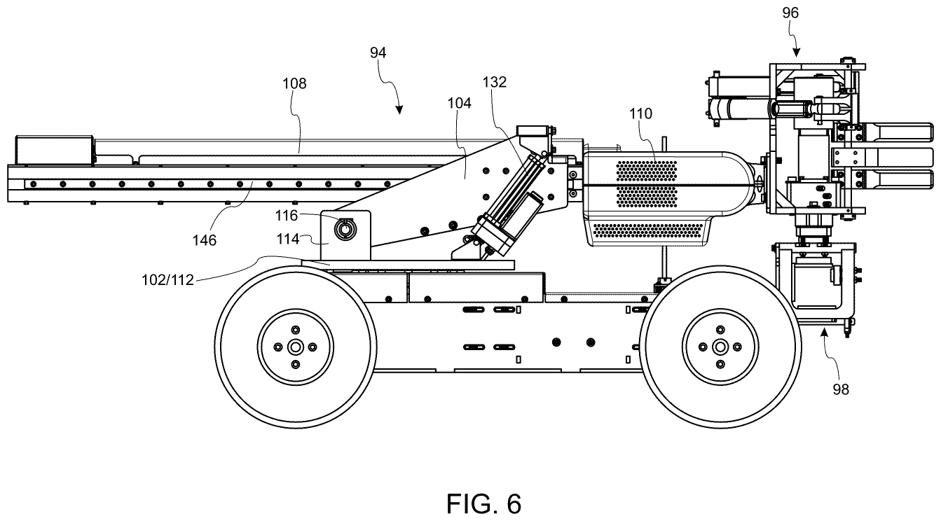

In another illustrative arrangement, a camera 64 may be positioned within or adjacent to a portion of front member 40 of body 22 in addition to camera 64 shown in FIGS. 3-6. Additional cameras 64 may be positioned within or adjacent to a portion of rear member 44 and/or sides members 42 of body 22, while yet another camera 64 may be positioned adjacent to plant engagement member 96 (which is described in further detail below). Accordingly, the scope of the present disclosure is in no way limited to the specific number of or positioning of various cameras 64 unless otherwise indicated in the following claims.

### Identification System 66:

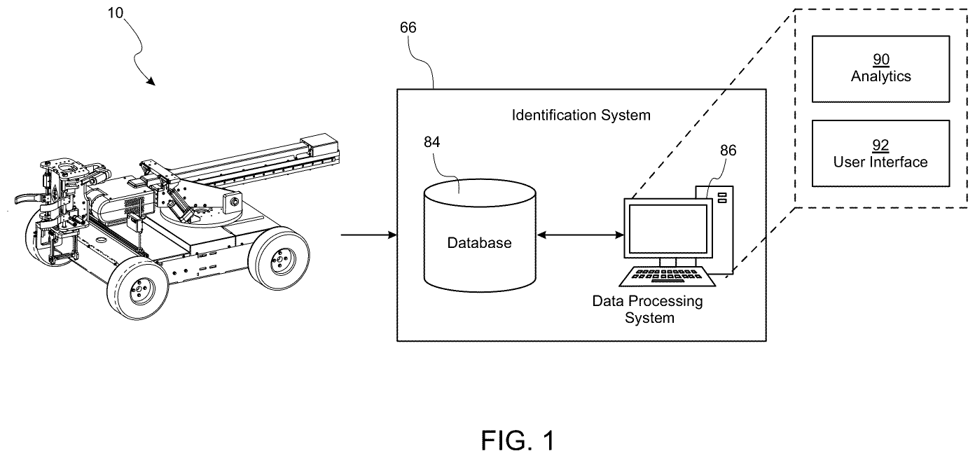

In the illustrative arrangement shown, as one example, optical module 26 includes identification system 66, a flowchart depiction of which is shown in FIG. 1. Identification system 66 is formed of any suitable size, shape, and design and is configured to receive images from camera 64 and process those images to facilitate identification of invasive species and/or target plants. In the illustrative arrangement shown, as one example, identification system 66 may include a database 84 and a data processing system 86, among other components.

Database 84: In the illustrative arrangement shown, as one example, database 84 is formed of any suitable size, shape, design and is configured to facilitate storage and retrieval of data. In the illustrative arrangement shown, as one example, database 84 is local data storage connected to data processing system 86 (e.g., via a data bus, an electronic network, or any other suitable data connection method and/or apparatus without limitation unless otherwise indicated in the following claims). It is contemplated that in one or more arrangements database 84 may be remote storage or cloud-based service communicatively connected to data processing system 86 via one or more external communication networks.

In some various arrangements, images or video observed by camera 64 may be communicated to database 84 for storage directly (e.g., over an electronic network) from camera 64. Additionally or alternatively, in some various arrangements, images or video observed by camera 64 may be communicated to database 84 for storage indirectly (e.g., by data processing system 86).

Data Processing System 86: In the illustrative arrangement shown, as one example, data processing system 86 is formed of any suitable size, shape, and design and is configured to facilitate receipt, storage, and/or retrieval of information in database 84, execution of analytics processes 90, providing of a user interface 92, and/or implementation of various other modules, processes or software of system 10. In one or more arrangements, for example, such data processing system 86 includes a circuit specifically configured and arranged to carry out one or more of these or related operations/activities. For example, data processing system 86 may include discrete logic circuits or programmable logic circuits configured and arranged for implementing these operations/activities, as shown in the figures, described in the specification, and/or otherwise apparent to those skilled in the art in light of the present disclosure.

In certain embodiments, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources, etc.). For instance, computer processing circuits may be programmed to execute a set (or sets) of instructions (and/or configuration data). The instructions (and/or configuration data) can be in the form of firmware or software stored in and accessible from a memory (circuit). Certain embodiments are directed to a computer program product (e.g., nonvolatile memory device), which includes a machine or computer-readable medium having stored thereon instructions, which may be executed by a computer (or other electronic device) to perform these operations/activities.

User Interface 92: In the illustrative arrangement shown, as one example, data processing system 86 includes user interface 92. User interface 92 is formed of any suitable size, shape, design, technology, and in any arrangement and is configured to facilitate user control and/or adjustment of various components of system 10. In one or more arrangements, as one example, user interface 92 includes a set of inputs (not shown). Inputs are formed of any suitable size, shape, and design and are configured to facilitate user input of data and/or control commands. In various different arrangements, inputs may include various types of controls including but not limited to, for example, buttons, switches, dials, knobs, a keyboard, a mouse, a touch pad, a touchscreen, a joystick, a roller ball, or any other form of user input. Optionally, in one or more arrangements, user interface 92 includes a display (not shown). Such display is formed of any suitable size, shape, design, technology, and in any arrangement and is configured to display information of settings, images captured or recorded by camera 64, time elapsed, and/or other information pertaining to vegetation/plants or other parameters relating to the area where system 10 is operating, and/or operation of system 10. In one or more arrangements, the display may include, for example, LED lights, meters, gauges, screen or monitor of a computing device, tablet, and/or smartphone and may be touch-sensitive.

Additionally, or alternatively, in one or more arrangements, the inputs and/or display may be implemented on a separate device that is communicatively connected to identification system 66. For example, in one or more arrangements, operation of identification system 66 may be customized or controlled using a smartphone or other computing device that is communicatively connected to the identification system 66 (e.g., via Bluetooth, WiFi, the internet, and/or other suitable methods and/or apparatuses).

In some example arrangements, data processing system 86 is configured to perform various tracking, analytics processes 90, and/or other operations described using images or video received from camera 64 and/or data stored in database 84. In one or more illustrative arrangements, as examples, data processing system 86 is configured to receive images and/or video from camera 64 and analyze such images and/or video to identify invasive species and/or target plants. In the illustrative arrangement shown, as one example, identification system 66 includes a database 84 that contains images of invasive species and/or target plants (or potential target plants), specifically various characteristics of the leaves (e.g., shape, size, color, etc.), bark (e.g., color, pattern, etc.), stems, or other identifying features and/or characteristics of invasive species and/or target plants. In the illustrative arrangement shown, as one example, the data processing system 86 then compares the images and/or videos (and/or the characteristics contained therein) from camera 64 with the images (and/or the characteristics contained therein) in database 84 and determines whether the images and/or videos captured or recorded by camera 64 are of invasive species and/or target plants.

In one illustrative embodiment of a process for identifying an invasive species and/or target plant, the identification system may first capture at least one image of a plant (either still image or video) using camera 64 of optical module 26. The various characteristics of the plant (e.g., shape, size, and/or color of leaf and/or stem, color and/or patterns of bark, etc.) shown in the image may be compared by data processing system 86 to preloaded images of known vegetative species, wherein those preloaded images show correlative characteristics of the known vegetative species. Depending on the specific plant, the characteristics may be at the class, subclass, order, family, genus, or species level without limitation unless otherwise indicated in the following claims. A threshold for matching correlative characteristics of the plant with those of known vegetative species may be determined, and it is contemplated that the optimal threshold for matching may vary from one application of system 10 to the next and depend at least upon the specific plant. In one illustrative embodiment, the threshold for matching may be 90% similarity in the shape of the leaf between the plant and the known vegetative species. In another illustrative embodiment the threshold for matching may be 70% similarity in the shape of the leaf in combination with 70% similarity in color of the bark. Other illustrative embodiments may use different characteristics and/or similarity percentages without limitation unless otherwise indicated in the following claims.

In any such illustrative embodiments, once the threshold for matching correlative characteristics has been determined, data processing system may undertake image comparison and processing as camera 64 captures image of plants in a specific area. When the determined threshold is met for any given image captured by camera 64, system 10 may either alert a user to the presence of the plant (as described in further detail below), or system 10 may position cutting module 28 adjacent the plant to perform a cutting operation autonomously (as described in further detail below). Other illustrative processes for identifying an invasive species and/or target plant will be evident to those skilled in the art in light of the present disclosure, and processes for identifying an invasive species and/or target plant disclosed and described herein are not meant to be limiting in any way unless otherwise indicated in the following claims.

### Machine Learning:

In one or more illustrative embodiments, data processing system 86 and/or other components of system 10 may be configured and arranged to monitor, learn, and modify one or more features, functions, and/or operations of system 10. For instance, analytics processes 90 of data processing system 86 may be configured to monitor and/or analyze data stored in database 84 and/or operation of system 10. As one example, in one or more illustrative arrangements, data processing system 86 may be configured to analyze the images and/or video, whether or not captured or recorded by camera 64 or stored/uploaded from another source, of invasive species and/or target plants and learn, over time, features indicative of invasive species and/or target plants, and/or algorithms for identification of invasive species and/or target plants. Such learning may include, for example, generation and refinement of neural networks and/or state machines configured to identify invasive species and/or target plants. In various illustrative embodiments, analysis by the data processing system 86 may include various guided and/or unguided artificial intelligence and/or machine learning techniques including, but not limited to: one or more neural networks, genetic algorithms, support vector machines, k-means, kernel regression, discriminant analysis and/or various combinations thereof. In different implementations, analysis may be performed locally, remotely, or a combination thereof.

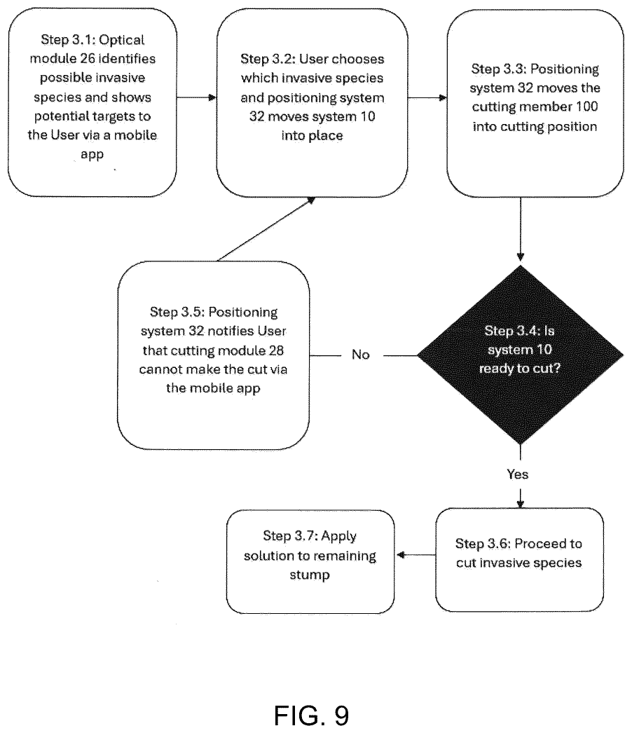

In one or more arrangements, images and/or video provided by camera 64 are processed by identification system 66 and if identification system 66 identifies what it believes is an invasive species and/or target plants, identification system 66 converts the information into a signal, such as a text message, email, or the like, which is transmitted to an electronic device (such as a cell phone, a handheld device, a mobile application, an email account, or any other electronic device capable of receiving an electronic message or information) the user of system 10. This signal includes the image and/or video of the identified invasive species and/or target plants captured or recorded by camera 64 and asks the user to confirm that it is in fact an image and/or video of an invasive species and/or target plants. With this timely information, the user of system 10 can quickly and effectively confirm/identify invasive species and/or target plants and, if it is in fact an invasive species and/or target plant, allow or instruct system 10 to perform a cutting operation using cutting module 28 as described in further detail below. In this illustrative arrangement, system 10 is operating in a semi-autonomous mode-that is, it initially identifies invasive species and/or target plants autonomously and then requires a user confirm before performing a cutting operation. This information is also stored in database 84 for data mining, data retrieval, data analytics, and/or machine learning and artificial intelligence purposes. Such an arrangement is depicted in the flowchart shown in FIG. 9 and discussed in further detail below.

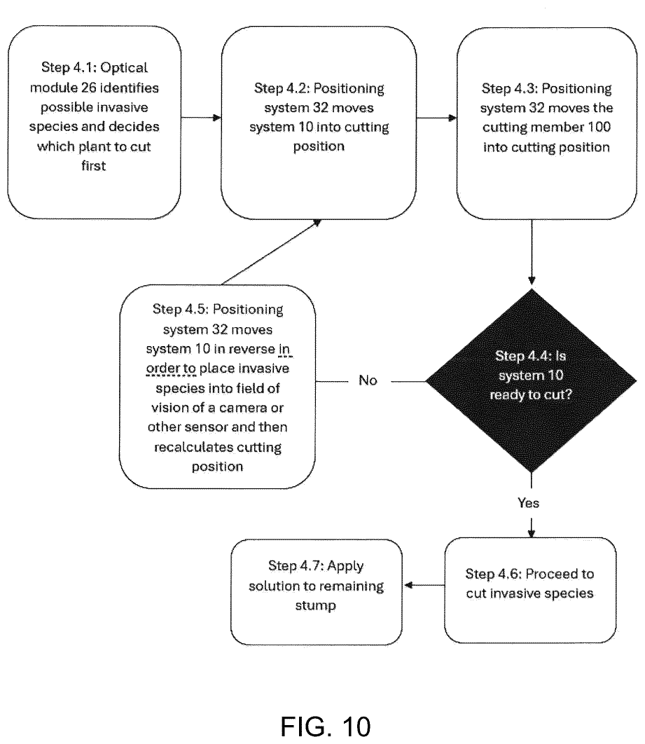

In one or more illustrative alternative arrangements shown, as one example, system 10 may be operating in a fully autonomous mode and, in such mode of operation, if the data processing system 86 confirms the images and/or videos captured or recorded by camera 64 are of an invasive species and/or target plants, system 10 will automatically perform a cutting operation on the invasive species and/or target plant using cutting module 28 without requiring confirmation from a user as described above for a semi-autonomous mode. Such an arrangement is depicted in the flowchart shown in FIG. 10 and discussed in further detail below.

In one or more further alternative arrangements, as one example, optical module 26 and/or identification system 66 may not perform the analytics process 90 described above. Rather, in one or more alternative arrangements, as examples, the images and/or videos from camera 64 may be sent directly to user interface 92 and the user of system 10 may, in real time, analyze the images and/or videos to identify invasive species and/or target plants. In this illustrative arrangement, as one example, if the user indicates the images and/or videos are of invasive species and/or target plants, then system 10 will perform a cutting operation on the invasive species and/or target plants using cutting module 28. If the user indicates the images and/or videos are not of invasive species and/or target plants, then system 10 will not perform a cutting operation.

In an illustrative arrangement, system 10 may employ one or more neural networks at a given step in the process of identifying, cutting, and/or spraying an invasive species and/or target plant. A first neural network may be employed to identify vegetation in a given environment/context to determine if a specific vegetation/plant is a target or non-target. For example, in one illustrative embodiment a first neural network may be configured to observe all vegetation in a given area (e.g., forest) and subsequently classify each species as a target or non-target. A second neural network may be employed as a classification neural network that maintains information on all relevant vegetation/plant species and communicates that information to system 10 so that system 10 may determine what species a specific vegetation/plant is, whether target or non-target. A third neural network may be employed to instruct system 10 where to cut the invasive species and/or target plant. That is the third neural network may be used to allow system 10 to distinguish between a branch, stump, limb, leaf, exposed root, etc. such that cutting module 28 engages the target vegetation/plant in the proper position to achieve the desired result.

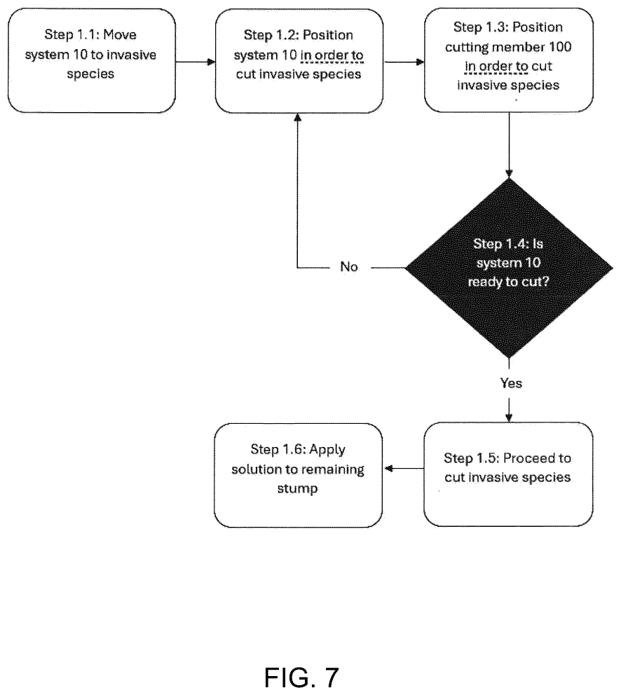

It is contemplated that in an illustrative arrangement, system 10 may first be deployed as a semi-autonomous system 10, wherein identification system 66 requires verification from a user that a specific vegetation/plant is an invasive species target and/or target plant, such that cutting module 28 is subsequently engaged to cut that specific vegetation/plant. This verification information may be used by identification system 66 to learn which vegetation/plants are targeted invasive species and/or target plant, and which are not, and when a sufficient number of user verifications have occurred, system 10 may move from semi-autonomous to autonomous for a given invasive species and/or target plant. Accordingly, the amount of user input required for system 10 to perform identifying, cutting, and/or spraying operations may vary from one invasive species and/or target plant to the next, and may change as system 10 is deployed in different locations and/or as the system is trained to properly identify a larger number of invasive species and/or target plants. Additionally or alternatively, images or videos of invasive species and/or target plants may be uploaded to identification system 66 and/or a classification neural network or identification neural network such that identification system may be trained without being deployed and with minimal need for user verification of a specific invasive species and/or target plant. Different levels of automation and associated user involvement are shown in the various flowcharts in FIGS. 7, 8, 9, and 10 and described in further detail below.

Generally, it is contemplated that an illustrative embodiment of an identification system 66 may use a computer vision and machine learning process, wherein an image dataset may be complied from an existing data source, an image data set gathered from camera 64, and/or a combination thereof. Each image in the dataset may be tagged with the correct species name, and specific parts and/or characteristics of the vegetation/plant (e.g., color and/or shape of leaves, bark, stems, etc.) may be annotated for more targeted and specific training of identification system 66. A semi-autonomous implementation of system 10 (such as that depicted in FIG. 9) may be used in evaluating the accuracy and precision of the identification system 66 for further refinement and/or for expansion of a catalogue of invasive species and/or target plants in database 84. Additionally, data processing system 86, analytics 90, and/or user interface 92 may be employed to further refine and/or train identification system 66 alone or in conjunction with machine learning/computer vision model. However, any suitable machine learning process, model, dataset, training method, neural network, computer program, and/or combinations thereof may be used with system 10 unless otherwise indicated in the following claims.

While optical module 26 and its various components have been described according to the illustrative arrangement shown, as one example, it will be understood by those skilled in the art that any other configuration of optical module and its various components may be used in order to allow system 10 identify various objects within the environment for which system 10 is deployed. The optimal configuration of optical module 26 and/or the components thereof may vary from one application of system 10 to the next and is therefore in no way limiting to the scope of the present disclosure unless otherwise indicated in the following claims.

### Cutting Module 28:

In the illustrative arrangement shown, as one example, system 10 includes cutting module 28. Cutting module 28 is formed of any suitable size, shape, and design and is configured to perform a cutting operation on invasive species and/or target plants. In the illustrative arrangement shown, as one example, cutting module 28 includes an arm assembly 94, a plant engagement member 96, a cutting member bracket 98, and a cutting member 100.

### Arm Assembly 94:

In the illustrative arrangement shown, as one example, cutting module 28 includes an arm assembly 94. Arm assembly 94 is formed of any suitable size, shape, and design and is configured to allow for the lateral, vertical, angular, and/or other movement of cutting member 100 for properly positioning thereof relative to a specific vegetation/plant. In the illustrative arrangement shown, as one example, arm assembly 94 includes a rotating member 102, a pair of angular members 104, an actuator assembly 106, an arm 108, and a tilt member 110.

In the illustrative arrangement shown, as one example, arm assembly 94 includes a rotating member 102. Rotating member 102 is formed of any suitable size, shape, and design and is configured to allow the cutting member 100 to be moved laterally (i.e., from side to side) and rotate with respect to body 22. In the illustrative arrangement shown, as one example, rotating member 102 includes a base 112, a bearing (not shown), an actuator (not shown), a bracket 114, and a connection member 116. Rotating member 102 may be configured to rotate with respect to body 22 by any suitable amount, such as 90 degrees, 180 degrees, 270 degrees, or even 360 degrees without limitation unless otherwise indicated in the following claims.

In the illustrative arrangement shown, as one example, rotating member 102 includes base 112. Base 112 is formed of any suitable size, shape, and design and is configured to operably engage various components of rotating member 102 and/or cutting member 28. In the illustrative arrangement shown, as one example, base 112 is a generally circular member with an upper surface, a lower surface, and an outer surface. In the illustrative arrangement shown, as one example, base 112 is formed of a single, unitary member that is formed in a manufacturing process such as machining, additive manufacturing, casting, or the like to form a unitary and monolithic member. Alternatively, base 112 may be formed of multiple pieces that are connected or assembled to one another through welding, bolting, friction fitting, screwing, or the like. Accordingly, the scope of the present disclosure is not limited to the specific manufacturing process and/or method used to construct base 112 and/or components thereof but extends to all known or later-developed manufacturing processes and/or methods without limitation unless otherwise indicated in the following claims.

In the illustrative arrangement shown, as one example, base 112 and/or components thereof are formed primarily of a metallic material such as steel, aluminum, chromium, or any other metallic material, alloy, and/or composite thereof. Alternatively, base 112 may be formed of a non-metallic material such as a plastic material, a fiberglass material, or any other non-metallic material and/or composite thereof. Accordingly, the material of construction of base 112 and/or components thereof is in no way limiting to the scope of the present disclosure and any suitable material currently known or later developed may be used unless otherwise indicated in the following claims.

In the illustrative arrangement shown, as one example, base 112 operably connects to/engages with second top section 48 of body 22 through a bearing (not shown). In the illustrative arrangement shown, as one example, the bearing of base 112 may be any suitable type or configuration of bearing currently available or later developed, and the bearing is configured to operably engage the lower surface of base 112 with the upper surface of second top section 48 of body 22 such that base 112 may rotate with respect to body 22. In the illustrative arrangement shown, as one example, the bearing of base 112 also allows base 112 to rotate relative to body 22 and base 112 is operably engaged with an actuator configured to facilitate rotation of base 112, which the bearing of base 112 helps facilitate. That is, actuator may case base 112 to rotate utilizing the bearing that operably engages base 112 to body 22 such that base 112 may rotate while body 22 remains stationary. In this way, base 112 helps facilitate the lateral (i.e., side to side) motion of cutting member 100.

In the illustrative arrangement shown, as one example, a bracket 114 is connected to the upper surface of base 112. Bracket 114 is formed of any suitable size, shape, and design and is configured to facilitate engagement of base 112 and the pair of angular members 104. In the illustrative arrangement shown, as one example, there are two brackets 114, one on the outer side of each of the pair of angular members 104. In the illustrative arrangement shown, as one example, brackets 114 are generally square, planar members which extend upward from the upper surface of base 112. In the illustrative arrangement shown, as one example, brackets 114 are formed of a single, unitary member that is formed in a manufacturing process such as machining, additive manufacturing, casting, or the like to form a unitary and monolithic member. Accordingly, the scope of the present disclosure is not limited to the specific manufacturing process and/or method used to construct bracket 114 and/or components thereof but extends to all known or later-developed manufacturing processes and/or methods without limitation unless otherwise indicated in the following claims.

In the illustrative arrangement shown, as one example, brackets 114 are formed primarily of a metallic material such as steel, aluminum, chromium, or any other metallic material, alloy, and/or composite thereof. Alternatively, brackets 114 may be formed of a non-metallic material such as a plastic material, a fiberglass material, or any other non-metallic material and/or composite thereof. Accordingly, the material of construction of bracket 114 and/or components thereof is in no way limiting to the scope of the present disclosure and any suitable material currently known or later developed may be used unless otherwise indicated in the following claims.

In the illustrative arrangement shown, as one example, rotating member 102 includes connection members 116. Connection members 116 are formed of any suitable size, shape, and design and are configured to operably connect/engage rotating member 102 to the pair of angular members 104. In the illustrative arrangement shown, as one example, there are two connection members 116. In the illustrative arrangement shown, as one example, each connection member 116 is a generally cylindrical member which extends through a bracket 114 and one of angular members 104, thereby engaging the pair of angular members 104 with brackets 114 and rotating member 102. In the illustrative arrangement, connection members 116 are configured to allow angular members 104 to rotate with respect to brackets 114 and rotating member 102 about an axis approximately at the radial center of the connection members 116.

In the illustrative arrangement shown, as one example, arm assembly 94 includes the pair of angular members 104. Angular members 104 are formed of any suitable size, shape, and design and are configured to operably connect to/engage with rotating member 102 and arm 108. In the illustrative arrangement shown, as one example, angular members 104 are generally flat and planar members which extend from one end near rearward end 14 of system 10, which connects to a bracket 114 as previously described, upward at an angle towards a second end near forward end 12 of system 10. In the illustrative arrangement shown, as one example, angular members 104 are each formed of a single, unitary member that is formed in a manufacturing process such as machining, additive manufacturing, casting, or the like to form a unitary and monolithic member. Accordingly, the scope of the present disclosure is not limited to the specific manufacturing process and/or method used to construct angular members 104 and/or components thereof but extends to all known or later-developed manufacturing processes and/or methods without limitation unless otherwise indicated in the following claims.

In the illustrative arrangement shown, as one example, angular members 104 are formed primarily of a metallic material such as steel, aluminum, chromium, or any other metallic material, alloy, and/or composite thereof. Alternatively, angular members 104 may be formed of a non-metallic material such as a plastic material, a fiberglass material, or any other non-metallic material and/or composite thereof. Accordingly, the material of construction of angular members 104 and/or components thereof is in no way limiting to the scope of the present disclosure and any suitable material currently known or later developed may be used unless otherwise indicated in the following claims.

In the illustrative arrangement shown, as one example, each angular member 104 has an interior surface and an exterior surface. In the illustrative arrangement shown, as one example, the interior surface of angular members 104 includes inner brackets 120. Inner brackets 120 are formed of any suitable size, shape, and design and are configured to engage and hold rails 146 of arm 108 therein in order to operably connect/engage arm 108 to angular members 104 and rotating member 102. In the illustrative arrangement shown, as one example, brackets 120 have a top side 122, a bottom side 124, and a channel 126 running between top side 122 and bottom side 124. In the illustrative arrangement shown, as one example, channel 126 is sized, shaped, and designed such that rails 146 of arm 108 fit therein and rest on top of bottom side 124 and loosely engage top side 122 in a manner which allows rails 146 of arm 108 to slide within channel 126 and move linearly relative to each angular member 104.

In the illustrative arrangement shown, as one example, angular member 104 also includes a top bracket 128. Top bracket 128 is formed of any suitable size, shape, and design and is configured to operably connect/engage two angular members 104 to each other and actuator assembly 106. In the illustrative arrangement shown, as one example, top bracket 128 is a generally flat and planar, rectangular member that extends between opposing ends of the two angular members 104. In the illustrative arrangement shown, as one example, top bracket 128 connects to/engages with each of angular members 104 near each opposing end of top bracket 128. In the illustrative arrangement shown, as one example, top bracket 128 connects to connection member 130 of each of actuators 132 of actuator assembly 106 at the opposing ends of top bracket 128.

In the illustrative arrangement shown, as one example, arm assembly 94 includes an actuator assembly 106. Actuator assembly 106 is formed of any suitable size, shape, and design and is configured to facilitate the vertical (i.e., upward and downward) motion of cutting member 100 with respect to body 22. In the illustrative arrangement shown, as one example, actuator assembly 106 includes a pair of connection members 130, a pair of actuators 132, and a pair of bases 134.

In the illustrative arrangement shown, as one example, actuator assembly 106 includes a pair of connection members 130. Connection members 130 are formed of any suitable size, shape, and design and are configured to operably connect to/engage with top bracket 128 of angular member 104 and to the pair of actuators 132, thereby engaging actuator assembly 106 to each angular member 104, rotating member 102, and to arm 108. In the illustrative arrangement shown, as one example, connection members 130 are generally triangular shaped, planar members that connect to/engage with bottom of top bracket 128 of angular member 104 and to the top of the pair of actuators 132.

In the illustrative arrangement shown, as one example, actuator assembly 106 includes a pair of actuators 132. Actuators 132 are formed of any suitable size, shape, and design and are configured to facilitate the vertical movement of arm 108 and, thereby, cutting member 100, with respect to at least body 22. In the illustrative arrangement shown, as one example, actuators 132 may be a hydraulic actuator, a pneumatic actuator, an electric actuator, or any other suitable types of actuator capable of being controlled remotely, manually, or autonomously through positioning system 32 currently know or later developed. In the illustrative arrangement shown, as one example, the pair of actuators 132 operate together in order to uniformly move arm 108. In the illustrative arrangement shown, as one example, the pair of actuators 132 operate to push upwards on top bracket 128, which causes angular member 104 to rotate upward about connection member 116, which in turn causes arm 108 to move upward. As arm 108 moves upward, cutting member 100 is likewise moved upward. In this way, actuators 132 facilitate the vertical movement of arm 108 and, thereby, cutting member 100.

In the illustrative arrangement shown, as one example, actuator assembly 106 also includes a pair of bases 134. Bases 134 are formed of any suitable size, shape, and design and are configured to operably connect/engage actuator assembly 106 to rotating member 102. In the illustrative arrangement shown, as one example, bases 134 are generally triangular shaped members which connect to the bottom of actuators 132 and to the upper surface of base 112 of rotating member 102.

In the illustrative arrangement shown, as one example, arm assembly 94 includes arm 108. Arm 108 is formed of any suitable size, shape, and design and is configured to facilitate the forward and rearward motion of cutting member 100 with respect to body 22. In the illustrative arrangement shown, as one example, arm 108 also helps to facilitate the lateral (i.e., side to side) and vertical (i.e., up and down) movement of cutting member 100 with respect to body 22 via its operable engagement with both of rotating member 102 and actuators 132, respectfully.

In the illustrative arrangement shown, as one example, arm 108 is formed of multiple pieces that are connected or assembled to one another through bolting, screwing, welding, friction fitting, or any other method of or apparatus for connecting materials. Alternatively, arm 108 may be formed of a single, unitary member that is formed in a manufacturing process such as machining, extrusion, forming, additive manufacturing, or the like to form a unitary and monolithic member. Accordingly, the scope of the present disclosure is not limited to the specific manufacturing process and/or method used to construct arm 108 and/or components thereof but extends to all known or later-developed manufacturing processes and/or methods without limitation unless otherwise indicated in the following claims.

In the illustrative arrangement shown, as one example, arm 108 is formed primarily of a metallic material such as steel, aluminum, chromium, or any other metallic material, alloy, and/or composite thereof. Alternatively, arm 108 may be formed of a non-metallic material such as a plastic material, a fiberglass material, or any other non-metallic material and/or composite thereof. Accordingly, the material of construction of arm 108 and/or components thereof is in no way limiting to the scope of the present disclosure and any suitable material currently known or later developed may be used unless otherwise indicated in the following claims.

In the illustrative arrangement shown, as one example, arm 108 includes a top surface 136, a bottom surface 138, opposing sides 140, a rearward end 142, a forward end 144, and rails 146. In the illustrative arrangement shown, as one example, when viewed from either top side 18 or bottom side 20 of system 10, arm 108 is a generally rectangular, extended member with rearward end 142 and forward end 144 extending in approximate parallel planar spaced relation to one another and in approximate perpendicular planar relation to each opposing side 140, with rails 146 extending outward from each opposing side 140. In the illustrative arrangement shown, as one example, when viewed from either side 16 of system 10, arm 108 is a generally rectangular, extended member with rearward end 142 and forward end 144 extending in approximate parallel planar spaced relation to one another and in approximate perpendicular planar relation to both top surface 136 and bottom surface 138. In the illustrative arrangement shown, as one example, when viewed from either forward end 12 or rearward end 14 of system 10, arm 108 is a generally square or rectangular member with top surface 136 and bottom surface 138 extending in approximate parallel planar spaced relation to one another and in approximate perpendicular planar relation to each opposing side 140, with rails 146 extending outward from each opposing side 140.

In the illustrative arrangement shown, as one example, arm 108 includes rails 146. Rails 146 are formed of any suitable size, shape, and design and are configured to facilitate operable connection between arm 108 and angular member 104 and help facilitate the forward and/or rearward movement of arm 108 and cutting member 100 with respect to body 22. In the illustrative arrangement shown, as one example, rails 146 are sized, shaped, and designed to be received and held within channel 126 in bracket 120 of each angular member 104. In this way, arm 108 is operably engaged with each angular member 104 through the interaction between channel 126 of bracket 120 and rails 146.

In one or more illustrative arrangements, as examples, rails 146 are also configured to facilitate movement of arm 108 in the forward and rearward directions with respect to body 22. In the illustrative arrangement shown, as one example, rails 146 may include any number of rollers or wheels, and a chain or ring around the outside of rails 146 and a motor. In the illustrative arrangement shown, as one example, the motor of rails is an electric motor, however any other type of motor, engine, or power source may be used in order to facilitate movement of the rollers or wheels of rails 146, such as a gas engine, a diesel engine, a solar energy source, a wind powered energy source, or any other source of energy or power.

In this illustrative arrangement, as one example, rotation of the motor causes the wheels and/or rollers to rotate and the rotation of the wheels and/or rollers may cause the chain or ring around the outside of rails 146 to also rotate. In this illustrative arrangement, as one example, when the chain or ring around the outside of rails 146 rotates, the chain or ring frictionally engages brackets 120 and, because brackets 120 are forced in place, the rotation of chain or ring causes arm 108 to move either forward or rearward with respect to angular member 104 (and consequently with respect to body 22) depending on the direction of rotation of the chain or ring of rails 146. In the illustrative arrangement shown, as one example, the forward and/or rearward movement of arm 108 causes tilt member 110 to move forward and/or rearward, which eventually leads to the forward and/or rearward movement of cutting member 100 with respect to body 22.

In the illustrative arrangement shown, as one example, arm assembly 94 includes a tilt member 110. Tilt member 110 is formed of any suitable size, shape, and design and is configured to facilitate angular movement of cutting member 100 (i.e., tilt member 110 facilitates the upward or downward tilt of cutting member 100 in order to place the blade of cutting member 100 in an acceptable cutting position) with respect to body 22. In the illustrative arrangement shown, as one example, tilt member 110 includes a housing 150, a motor (not shown), a rotating member 152, and an engagement member 154.

In the illustrative arrangement shown, as one example, tilt member 110 includes a housing 150. Housing 150 is formed of any suitable size, shape, and design and is configured to operably connect to/engage with forward end 144 of arm 108 and house the motor of tilt member 110. In the illustrative arrangement shown, as one example, housing 150 connects at its rearward end to forward end 144 of arm 108 through any means of or apparatus for direct or indirect connection, including but not limited to the use of brackets, spacers, or other members, and through any means of or apparatus for connecting two pieces including screwing, bolting, riveting, welding, adhesion, friction fitting, or any other means of or apparatus for connecting two pieces without limitation unless otherwise indicated in the following claims.

In the illustrative arrangement shown, as one example, housing 150 houses the motor of tilt member 110. The motor of tilt member 110 is formed of any suitable size, shape, and design and is configured to facilitate the rotation of rotating member 152 and, ultimately, the angular movement of cutting member 100 with respect to forward end 144 of arm 108 and certain other components of cutting module 26. In the illustrative arrangement shown, as one example, the motor of tilt member 110 is an electric motor, however any other type of motor, engine, or power source may be used in order to facilitate the rotation of rotating member 152, such as a gas engine, a diesel engine, a solar energy source, a wind powered energy source, or any other source of energy or power.

In the illustrative arrangement shown, as one example, the motor may include a drive shaft, or connect to an axle, which is operably engaged with the rotating member 152. Rotating member 152 is formed of any suitable size, shape, and design and is configured to rotate in order to cause the angular movement of cutting member 100 with respect to forward end 144 of arm 108 and certain other components of cutting module 26. In the illustrative arrangement shown, as one example, rotating member 152 is a generally cylindrical member extending between opposing sides and having a peripheral surface. In the illustrative arrangement shown, as one example, the drive shaft and/or axle of the motor of tilt member 110 may extend through the middle of rotating member 152 such that when the motor operates, the drive shaft and/or axle is configured to rotate and thereby causes the rotating member 152 to rotate as well. This, in turn, causes the angular movement of cutting member 100 with respect to at least forward end 144 or arm 108.

In the illustrative arrangement shown, as one example, rotating member 152 includes an engagement member 154 extending outward from a portion of the peripheral surface of rotating member 152. Engagement member 154 is formed of any suitable size, shape, and design and is configured to operably engage plant engagement member 96. In the illustrative arrangement shown, as one example, engagement member 154 may be a block or other member with holes formed therein in order to be screwed or bolted to rotating plant engagement member 96. However, engagement member 154 may be differently configured in other arrangements of a system 10 as disclosed herein, and any suitable configuration that operably engages rotating member 152 with plant engagement member 96 may be used without limitation unless otherwise indicated in the following claims

### Plant Engagement Member 96:

In the illustrative arrangement shown, as one example, cutting module 28 includes a plant engagement member 96. Plant engagement member 96 is formed of any suitable size, shape, and design and is configured to grasp and hold invasive species and/or target plants during a cutting operation in order to provide leverage for cutting member 100 to cut the invasive species and/or target plant, ensure the proper position of the invasive species and/or target plant with respect to cutting member 100, and/or otherwise secure the relative positions of an invasive species and/or target plant and one or more components of system 10. In the illustrative arrangement shown, as one example, plant engagement member 96 includes a frame 158, rods 160, clamp members 162, clamp actuators 164, and a linear actuator 166.

In the illustrative arrangement shown, as one example, plant engagement member 96 is formed of multiple pieces that are connected or assembled to one another through bolting, screwing, welding, adhesion, or any other means of or apparatus for connecting two members. In the illustrative arrangement shown, as one example, plant engagement member 96 is formed primarily of a metallic material such as steel, aluminum, chromium, or any other metallic material, alloy, and/or composite thereof. Alternatively, plant engagement member 96 may be formed of a non-metallic material such as a plastic material, a fiberglass material, or any other non-metallic material and/or composite there. Accordingly, the material of construction of plant engagement member 96 and/or components thereof is in no way limiting to the scope of the present disclosure and any suitable material currently known or later developed may be used unless otherwise indicated in the following claims.

In the illustrative arrangement shown, as one example, plant engagement member 96 includes frame 158. Frame 158 is formed of any suitable size, shape, and design and is configured to operably connect the various components of plant engagement member 96. In the arrangement shown, as one example, frame 158 is generally rectangular in shape extending between a top side and a bottom side. In the illustrative arrangement shown, as one example, the forward end, as well as the opposing sides of frame 158 are generally open and accessible. That is, in the illustrative arrangement shown, as one example, frame 158 has a top wall 170, a bottom wall 172, and a rear wall 174, but no front wall or side walls. In this illustrative arrangement, as one example, the various components of plant engagement member 96 have more room to operate, connect to one another, and are also easier to reach if servicing and/or repair of plant engagement member 96 are necessary.

In the illustrative arrangement shown, as one example, top wall 170 and bottom wall 172 are connected via rods 160. Rods 160 are formed of any suitable size, shape, and design and are configured to operably connect/engage top wall 170 and bottom wall 172, as well as provide rigidity and proper spacing between top wall 170 and bottom wall 172. In the illustrative arrangement shown, as one example, rods 160 are generally cylindrical, elongated members that extend between a top end 176 and a bottom end 178. In the illustrative arrangement shown, as one example, the top end 176 of rods 160 are located above top wall 170 of frame 158, the rods 160 extend downward, through both top wall 170 and bottom wall 172 before reaching bottom end 178, which rests below bottom wall 172 of frame 158.

In the illustrative arrangement shown, as one example, there are collars 180 on each of the top end 176 and bottom end 178 of rods 160. In the illustrative arrangement shown, as one example, collars 180 ensure that rods 160 are securely connected to top wall 170 and bottom wall 172. In the illustrative arrangement shown, as one example, collars 180 are generally cylindrical members that fit around the outside of rods 160 and securely engage rods 160 such that when pressure is placed on collars 180, such as gravity, collars 180 do not move relative to rods 160. In the illustrative arrangement shown, as one example, collars 180 are placed near the top end 176 and/or bottom end 178, respectively, or rods 160 at the point where rods 160 intersect top wall 170 and/or bottom wall 172, respectively. With collars 180 properly placed, rods 160 are prevented from moving relative to top tall 170 and bottom wall 172, and top wall 170 and bottom wall 172 are prevented from moving relative to each other as well. In this way, in the illustrative arrangement shown, as one example, with collars 180 properly placed, rods 160 operably connect/engage top wall 170 and bottom wall 172, as well as provide rigidity and proper spacing between top wall 170 and bottom wall 172.

In the illustrative arrangement shown, as one example, plant engagement member 96 includes clamp members 162. Clamp members 162 are formed of any suitable size, shape, and design and are configured to grasp invasive species and/or target plants when system 10 is performing a cutting operation or for other operations. In the illustrative arrangement shown, as one example, there are three clamp members 162, however any other number of clamp members 162 may be used in order to grasp invasive species and/or target plants when system 10 is performing a cutting or other operation. In the illustrative arrangement shown, as one example, when clamp members 162 grasp an invasive species and/or target plant, the invasive species and/or target plant is prevented from moving away from the cutting member 100 when the cutting member is attempting to cut through the invasive species and/or target plant.

In the illustrative arrangement shown, as one example, clamp members 162 are elongated members which have a convex curvature to them as they extend forward from the frame 158 of plant engagement member 96. In the illustrative arrangement shown, as one example, this convex curvature allows for clamp members 162 to grasp the typically rounded stumps of invasive species and/or target plants.

In the illustrative arrangement shown, as one example, clamp members 162 are operably connected to/engaged with rods 160 of plant engagement members 96 within close and tight tolerances such that clamp members 162 and rods 160 are frictionally engaged such that rotation of a rod 160 causes rotation of clamp member(s) 162 engaged with that rod 160. In the illustrative arrangement shown, as one example, there is one clamp member 162 connected to one rod 160 and two clamp members 162 connected to the other rod 160. In the illustrative arrangement shown, as one example, single clamp member 162 is positioned near the center of its respective rod 160, and clamp members 162 on the other rod 160 are positioned such that one clamp member 162 is higher on rod 160 and the other clamp member 162 is lower on rod 160. In this illustrative arrangement, as one example, clamp members 162 operate together to grasp the invasive species and/or target plant at three different contact points and provide stability in its grasping of the invasive species and/or target plant.

In the illustrative arrangement shown, as one example, clamp members 162 are configured to move to a clamped position due to the use of clamp actuators 164. Clamp actuators 164 are formed of any suitable size, shape, and design and are configured to facilitate the movement of clamp members 162 in order for clamp members 162 to grasp invasive species and/or target plant. In the illustrative arrangement shown, as one example, clamp actuators 164 may be hydraulic actuators, pneumatic actuators, electric actuators, or any other type of actuators capable of being controlled remotely, manually, or autonomously through positioning system 32.

In the illustrative arrangement shown, as one example, there are two clamp actuators 164, with one clamp actuator 164 connected to/engaged with one rod 160 and the other clamp actuator 164 connected to/engaged with the other rod 160 of plant engagement member 96. In the illustrative arrangement shown, as one example, clamp actuators 164 engage each rod 160 in close and tight tolerances such that when clamp actuators 164 are operated, they cause rods 160 to rotate, which causes the clamp members 162 to move either inward (to grasp as invasive species and/or target plant) or outward (to release an invasive species and/or target plant). In the illustrative arrangement, extending clamp actuator 164 decreases the distance between opposing clamp members 162 (e.g., move to grasp an invasive species and/or target plant), and retracting clamp actuator 164 increases the distance between opposing clamp members 162 (e.g., move to release an invasive species and/or target plant).

In the illustrative arrangement shown, as one example, plant engagement member 96 includes a linear actuator 166. Linear actuator 166 is formed of any suitable size, shape, and design and is configured to facilitate additional lateral (i.e., side to side) movement of cutting member bracket 98. In the illustrative arrangement shown, as one example, linear actuator 166 may include a motor (not shown) and a track (not shown) that operate to cause the lateral movement of cutting member bracket 98 with respect to body 22 and/or other components of system 10. In the illustrative arrangement shown, as one example, linear actuator 166 includes a connection member 184 configured to operably connect to/engage with cutting member bracket 98, thereby connecting linear actuator 166, and plant engagement member 96, to cutting member bracket 98.

### Cutting Member Bracket 98:

In the illustrative arrangement shown, as one example, cutting module 28 includes cutting member bracket 98. Cutting member bracket 98 is formed of any suitable size, shape, and design and is configured to support and hold cutting member 100. In the illustrative arrangement shown, as one example, cutting member bracket 98 includes a top wall 186, a first support member 188, and a second support member 190.

In the illustrative arrangement shown, as one example, cutting member bracket 98 is formed of multiple pieces that are connected or assembled to one another through bolting, however any other means of or apparatus for connecting or assembling the multiple pieces may be used including screwing, welding, friction fitting, or the like. Alternatively, cutting member bracket 98 may be formed of a single, unitary member that is formed in a manufacturing process such as machining, casting, additive manufacturing, or the like to form a unitary and monolithic member. Accordingly, the scope of the present disclosure is not limited to the specific manufacturing process and/or method used to construct the cutting member bracket 98 and/or components thereof but extends to all known or later-developed manufacturing processes and/or methods without limitation unless otherwise indicated in the following claims.

In the illustrative arrangement shown, as one example, cutting member bracket 98 is formed of a metallic material such as steel, aluminum, chromium, or any other metallic material, alloy, and/or composite thereof. Alternatively, cutting member bracket 98 may be formed of a non-metallic material such as a plastic material, a fiberglass material, or any other non-metallic material and/or composite thereof. Accordingly, the material of construction of cutting member bracket 98 and/or components thereof is in no way limiting to the scope of the present disclosure and any suitable material currently known or later developed may be used unless otherwise indicated in the following claims.

In the illustrative arrangement shown, as one example, cutting member bracket 98 includes top wall 186. Top wall 186 is formed of any suitable size, shape, and design and is configured to operably connect/engage cutting member bracket 98 to connection member 184 of linear actuator 166 of plant engagement member 96. In the arrangement shown, as one example, top wall 186 is a generally flat and planar member that extends a length between opposing ends and a width between opposing sides. In the illustrative arrangement shown, as one example, first support member 188 and second support member 190 operably connect to the opposing sides of top wall 186.

In the illustrative arrangement shown, as one example, cutting member bracket 98 includes a first support member 188. First support member 188 is formed of any suitable size, shape, and design and is configured to help support cutting member 100. In the illustrative arrangement shown, as one example, first support member 188 includes a pair of vertical members 192 and a bottom member 194. In the illustrative arrangement shown, as one example, each vertical member 192 operably connects to/engages with an opposing side of top wall 186 and vertical members 192 extend downward a distance from top wall 186. In the illustrative arrangement shown, as one example, bottom member 194 extends between, and operably connects, vertical members 192 to each other in order to hold vertical members 192 together. In the illustrative arrangement shown, as one example, the opening between the bottom of top wall 186 and the top of bottom member 194 is sufficient to allow cutting member 100 to be extended through such opening.

In the illustrative arrangement shown, as one example, cutting member bracket 98 includes a second support member 190. Second support member 190 is formed of any suitable size, shape, and design and is configured to help support cutting member 100. In the illustrative arrangement shown, as one example, second support member 190 also includes a pair of vertical members 196 and a bottom member 198. In the illustrative arrangement shown, as one example, each vertical member 196 operably connects to/engages with an opposing side of top wall 186 and vertical members 196 extend downward a distance from top wall 186. In the illustrative arrangement shown, as one example, bottom member 198 extends between, and operably connects, the vertical members 196 to each other in order to hold vertical members 196 together. In the illustrative arrangement shown, as one example, the opening between the bottom of top wall 186 and the top of bottom member 198 is sufficient to allow cutting member 100 to be extended through such opening.

### Cutting Member 100:

In the illustrative arrangement shown, as one example, cutting module 28 includes cutting member 100. Cutting member 100 is formed of any suitable size, shape, and design and is configured to cut vegetation/plants identified as invasive species and/or target plants. In various arrangements, as examples, cutting member 100 may be any type of machine or device configured to cut material including, but not limited to, a chain saw, a saw, shears, an axe, a hatchet, a machete, a laser cutter, a plasma cutter, or any other device capable of cutting invasive species and/or target plants. In the illustrative arrangement shown, as one example, cutting member 100 is configured to be securely held and supported by cutting member bracket 98.

In the illustrative arrangement shown, as one example, when the optical module 26 is used to identify an invasive species and/or target plant, cutting module 28 performs a cut. Once cutting module 28 is finished performing the cut, spraying module 30 sprays the remains of the invasive species and/or target plant with a solution to eradicate it.

While cutting module 28 and its various components have been described according to the illustrative arrangement shown, as one example, it will be understood by those skilled in the art that any other configuration of cutting module 28 and its various components may be used in order to perform a cutting and/or grasping operation on a target or non-target vegetation/plant species (invasive or not), and which may be configured to specifically for use with a target invasive species. The optimal configuration of cutting module 28 and/or the components thereof may vary from one application of system 10 to the next and is therefore in no way limiting to the scope of the present disclosure unless otherwise indicated in the following claims.

### Spraying Module 30:

In one or more illustrative arrangements, as examples, system 10 includes spraying module 30. Spraying module 30 is formed of any suitable size, shape, and design and is configured to spray the remains of the invasive species and/or target plant with a solution to eradicate it and may be performed after the cutting operation. In one or more illustrative arrangements, as examples, spraying module 30 may include a reservoir configured to hold the solution being sprayed on the invasive species and/or target plants. In one or more illustrative arrangements, as examples, spraying module 30 may also include a hose, pipe, or other conduit (not shown) and a pump (not shown) to facilitate the spraying of the solution onto the invasive species and/or target plants. In one or more illustrative arrangements, as examples, spraying module 30 may also include a nozzle configured to properly direct the flow of the solution onto the invasive species and/or target plants. These and other components may be used in spraying module 30 without departing from the scope of this disclosure unless otherwise indicated in the following claims.

In one or more illustrative arrangements, the solution used in spraying module 30 may be a herbicide such as glyphosate, triclopyr, foliar herbicide, a cut-stump herbicide, a basal bark herbicide, or any other types of herbicide, solution, and/or combinations thereof. However, any suitable solution capable of killing a specific target species (invasive or otherwise) may be used in the spraying module 30 without limitation unless otherwise indicated in the following claims.

In an illustrative arrangement of system 10, an outlet for the solution from spraying module 30 (e.g., one or more nozzles) may be positioned adjacent to and/or move with plant engagement member 96. In such an arrangement, it is contemplated that the same or nearly the same position of plant engagement member 96 and the outlet for the solution from spraying module 30 may be required for both the cutting and spraying operation of the system 10. That is, the outlet for the solution from spraying module 30 may be positioned with respect to the plant engagement member 96 such that after the cutting operation is performed, the system 10 may immediately perform the spraying operation because the outlet for the solution from spraying module 30 is already correctly positioned to apply solution to the remains of the target vegetation/plant. Accordingly, such an arrangement may provide increased efficiency of system 10 because no additional positioning of any component of the system 10 would be required between the cutting operation and the spraying operation.

In still another illustrative arrangement of system 10, an outlet for the solution from spraying module 30 (e.g., one or more nozzles) may be positioned on a separate component and/or move independently from plant engagement member 96. In such an arrangement, it is contemplated that different positions of plant engagement member 96 and the outlet for the solution from spraying module 30 may be achieved simultaneously such that one target plant a solution may be applied to a first target vegetation/plant while a cutting operation may be simultaneously performed on a second target vegetation/plant

While spraying module 30 and various components have been described according to the illustrative arrangement shown, as one example, it will be understood by those skilled in the art that any other configuration of spraying module 30 and/or the various components thereof may be used in order to perform a spraying operation on an identified invasive species and/or other target plants. The optimal configuration of spraying module 30 and/or the components thereof may vary from one application of the system 10 to the next and is therefore in no way limiting to the scope of the present disclosure unless otherwise indicated in the following claims.

### Positioning System 32:

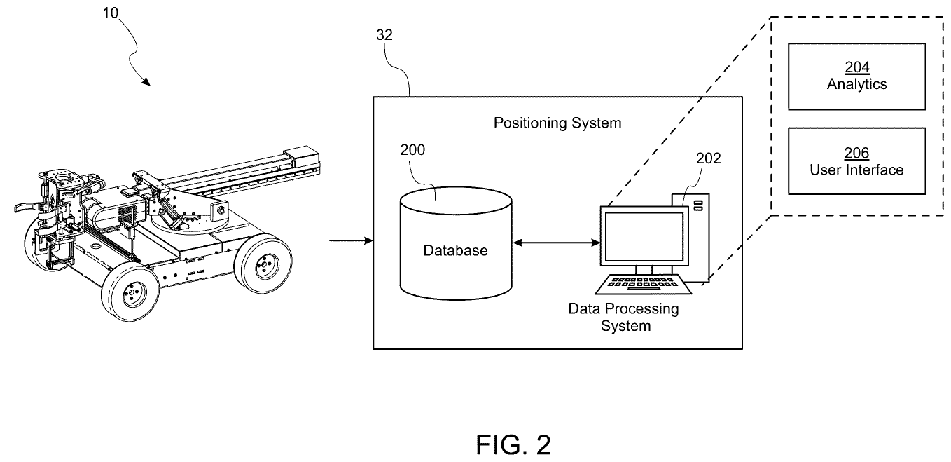

In the illustrative arrangement shown, as one example, system 10 includes positioning system 32. Positioning system 32 is formed of any suitable size, shape, and design and is configured to control the position of system 10 and cutting member 100 in order to properly perform cutting operations and spraying operations using cutting module 28 and spraying module 30, respectively. In the illustrative arrangement shown, as one example, positioning system 32 includes a database 200 (optional) and a data processing system 202, among other components, as depicted schematically in FIG. 2.

### Database 200:

In the illustrative arrangement shown, as one example, positioning system 32 includes database 200. Database 200 is formed of any suitable size, shape, design and is configured to facilitate storage and retrieval of data. In the illustrative arrangement shown, as one example, database 200 is local data storage connected to data processing system 202 (e.g., via a data bus or an electronic network). However, the embodiments are not so limited. Rather, it is contemplated that in one or more arrangements database 200 may be remote storage or cloud-based service communicatively connected to data processing system 202 via one or more external communication networks.

In some various arrangements, images and/or videos captured by camera 64 or information recorded by any other sensor may be communicated to database 200 for storage directly (e.g., over an electronic network). Additionally or alternatively, in some various arrangements, images and/or videos captures by camera 64 or information recorded by any other sensor may be communicated to database 200 for storage indirectly (e.g., data processing system 202).

### Data Processing System 202:

Data processing system 202 is formed of any suitable size, shape, and design and is configured to facilitate receipt, storage, and/or retrieval of information in database 200, execution of analytics processes 204, providing of a user interface 206, and/or implementation of various other modules, processes, or software of system 10. In one or more illustrative arrangements, for example, such data processing system 202 includes a circuit specifically configured and arranged to carry out one or more of these or related operations/activities. For example, data processing system 202 may include discrete logic circuits or programmable logic circuits configured and arranged for implementing these operations/activities, as shown in the figures, and/or described in the specification. In certain embodiments, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of instructions (and/or configuration data). The instructions (and/or configured data) can be in the form of firmware or software stored in and accessible from a memory (circuit). Certain embodiments are directed to a computer program product (e.g., nonvolatile memory device), which includes a machine or computer-readable medium having stored thereon instructions, which may be executed by a computer (or other electronic device) to perform these operations/activities.

### User Interface 206:

User interface 206 is formed of any suitable size, shape, design, technology, and in any arrangement and is configured to facilitate user control and/or adjustment of various components of system 10. In one or more illustrative arrangements, as examples, user interface 206 may be the same as user interface 92 or may be different than user interface 92. In one or more illustrative arrangements, as one example, user interface 206 includes a set of inputs (not shown). Inputs are formed of any suitable size, shape, and design and are configured to facilitate user input of data and/or control commands. In various different arrangements, inputs may include various types of controls including but not limited to, for example, buttons, switches, dials, knobs, a keyboard, a mouse, a touch pad, a touchscreen, a joystick, a roller ball, or any other form of user input. Optionally, in one or more arrangements, user interface 206 includes a display (not shown). Such display is formed of any suitable size, shape, design, technology, and in any arrangement and is configured to display information or settings, sensor readings, images and/or video captured or recorded by camera 64, time elapsed, and/or other information pertaining to the positioning, operation, and navigation of system 10. In one or more arrangements, the display may include, for example, LED lights, meters, gauges, screen or monitor of a computing device, tablet, and/or smartphone.

Additionally, or alternatively, in one or more arrangements, the inputs and/or display may be implemented on a separate device that is communicatively connected to positioning system 32. For example, in one or more arrangements, operation of positioning system 32 may be customized or controlled using a smartphone or other computing device that is communicatively connected to positioning system 32 (e.g., via Bluetooth, WiFi, and/or the internet).

### Analytics Processes 204:

In some illustrative arrangements, data processing system 202 is configured to perform various tracking, analytics processes 204, and/or other operations described herein using images and/or videos from camera 64, any other information or data received from other sensors on system 10, and/or data stored in database 200.

In one illustrative arrangement, analytics processes 204 are configured to analyze images and/or video from camera 64 or data of a sensor such as an accelerometer to identify the position and motions of system 10. Identification of the positioning and motions is necessary to ensure system 10 is properly positioned to perform cutting operations and spraying operations and, more generally, to move around in forested or other environments or terrain where system 10 is removing invasive species and/or target plants. In one or more illustrative arrangements, sensors and/or additional camera may be included in cutting module 28 and/or spraying module 30 in order for analytics processes 204 to analyze the relative positions of cutting member 100 and the nozzle of spraying module 30, respectively, in order to ensure proper positioning of system 10 to perform cutting and spraying operations. In one or more illustrative arrangements, analytics processes 204 may be configured to identify any number of different motions needed to be made to system 10 and/or cutting module 30 in order to properly position system 10 in order to perform cutting and spraying operations on invasive species and/or target plants and to traverse the environment or terrain where system 10 is located. In one or more illustrative arrangements, the different motions that may be necessary include but are not limited to, for example, moving system 10 as a whole forward, backward, left, or right, or moving cutting member 100 left or right (using either the rotating member 102 of arm assembly 94 or the linear actuator 166 of plant engagement member 96), moving cutting member 100 forward or rearward (using rails 146 of arm 108), or moving cutting member 100 in an angular manner (using tilt member 110).

In one or more illustrative arrangements, analytics processes 204 may also be able to identify when system 10 has encountered an obstacle in the environment or terrain where system 10 is operating and perform necessary movements to remove itself from the obstacle and avoid running into the obstacle again. In one or more illustrative arrangements, system 10 has been trained in a virtual environment which, as one example, simulates a forested environment. In one or more illustrative arrangements, in such virtual environment system 10 encountered potential obstacles and, using positioning system 32, learned how to remove itself from those obstacles and avoid running into them again. In this illustrative arrangement, as one example, positioning system 32 essentially learned using unguided artificial intelligence and/or machine learning techniques including, but not limited to: neural networks, genetic algorithms, support vector machines, k-means, kernel regression, discriminant analysis and/or various combinations thereof. In this illustrative arrangement, as one example, the data learned during such learning is stored in database 200. In this illustrative arrangement, analytics processes 204 may regularly retrieve images and/or video from camera 64 or any other camera, or any other data or information from sensors on system 10 and compare such information with images, video, information, and/or data in database 200 for evaluation while system 10 is operating, and/or when system 10 encounters an obstacle. After retrieving the data, analytics processes 204 processes the data using, for example, a classifier, state machine, or other machine learning algorithm that is trained as set forth above. In this illustrative arrangement, after processing the data, analytics processes 204 determines a set of motions for system 10 to take in order to remove itself from the obstacle and avoid running into the obstacle again.

As noted above, in one or more embodiments, positioning system 32 and/or other components of system 10 may be configured and arranged to monitor, learn, and modify one or more features, functions, and/or operations of system 10. For instance, analytics processes 204 of positioning system 32 may be configured to monitor and/or analyze data stored in database 200 and/or operation of system 10. As one example, in one or more illustrative arrangements, positioning system 32 may be configured to analyze the data and learn, over time, data metrics indicative of approaching and/or encountering an obstacle in various environments or terrain. Such learning may include, for example, generation and refinement of neural networks and/or state machines configured to map input data values to outcomes of interest or to operations to be performed by system 10. In various embodiments, analysis by the positioning system 32 may include various guided and/or unguided artificial intelligence and/or machine learning techniques including, but not limited to: neural networks, genetic algorithms, support vector machines, k-means, kernel regression, discriminant analysis, and/or various combinations thereof. In different implementations, analysis may be performed locally, remotely, or a combination thereof.

### Control Assembly 34:

In the illustrative arrangement shown, as one example, system 10 includes control assembly 34. Control assembly 34 is formed of any suitable size, shape, and design and is configured to control operation of system 10 and its components. In one or more illustrative arrangements, as examples, control assembly 34 includes a remote controller. The remote controller is formed of any suitable size, shape, and design and is configured to control the speed and direction of movement of system 10, and, in various arrangements, the movement of arm assembly 108. In one or more illustrative arrangements, as examples, the remote controller may be the same as user interface 92 and/or user interface 206, among other components described herein. In various alternative arrangements, as examples, control assembly 34 may be any other type of configuration of a wired or wireless remote controller and may have knobs, one or more joysticks, a steering wheel, or any other method or means of or apparatus for controlling the movement of system 10 and/or arm assembly 108.

While control assembly 34 and its various components have been described according the illustrative arrangement shown, as one example, it will be understood by those skilled in the art that any other configuration of control assembly 34 and its components may be used in order to facilitate the remote operation and control of system 10 and its various components. The optimal configuration of control assembly 34 and/or the components thereof may vary from one application of system 10 to the next and is therefore in no way limiting to the scope of the present disclosure unless otherwise indicated in the following claims.

### Power Source 36:

In the illustrative arrangement shown, as one example, system 10 includes a power source 36. Power source 36 is formed of any suitable size, shape, and design and is configured to provide power to system 10 and various components of system 10. In the illustrative arrangement shown, as one example, power source 36 may be any source of power including, but not limited to, a battery, a gas-powered generator, a diesel-powered generator, a solar-powered generator or engine, a gas-powered engine, a diesel-powered engine, or any other type or configuration of generator or power source.

It is contemplated that in an illustrative arrangement of a system 10, body 22 may be configured such that various electrical and electronic components of drive system 24 optical module 26, cutting module 28, spraying module 30, positioning system 32, control assembly 34, and/or power source 36 may be positioned within body 22, and primarily within the space formed between top side 18 and bottom side 20 vertically and front member 40, rear member 44, and side members 42 horizontally. Additionally, it is contemplated that certain fluid handling components (e.g., pump, tank, etc.) for spraying module 30 may be positioned therein as well. However, other configurations may be used without departing from the scope of the present disclosure unless otherwise indicated in the following claims.

### In Operation:

In various illustrative arrangements, system 10 may be operated by a user of system 10, system 10 may operate in a semi-autonomous mode, or system 10 may operate in a fully autonomous mode without limitation unless otherwise indicated in the following claims.

### User Operated Mode:

In one or more illustrative arrangements, as examples, system 10 may be operated by a user. As shown in the figures, when system 10 is utilized in a given environment or terrain, the user generally follows Steps 1.1 through 1.6, as shown in FIG. 7. In Step 1.1, the user uses the remote controller of control assembly 34 (which may be user interface 92, user interface 206, and/or any other remote controller) to move system 10 towards a vegetation/plant that the user identified as an invasive species and/or a target plant. In Step 1.2, as system 10 gets close to the invasive species and/or target plant, the user uses the remote controller of control assembly 34 to position system 10 in the proper position to cut the invasive species and/or target plant.

In one or more illustrative arrangements, as examples, in Step 1.3, once system 10 as a whole, is in the proper position, the user must then move cutting member 100 to the correct position in order to cut the invasive species and/or target plant. In this illustrative arrangement, as one example, the user uses the remote controller of control assembly 34 to actuate the actuator of rotating member 102 of arm assembly 94, which causes rotating member 102 to rotate relative to body 22, which causes arm assembly 94, and subsequently cutting member 100, to move side-to-side, as needed. Additionally or alternatively, the user uses the remote controller of control assembly 34 to actuate linear actuator 166 to move cutting member bracket 98 from side-to-side, thereby causing cutting member 100 to move side-to-side, as needed.

In one or more illustrative arrangements, as examples, the user may also use the remote controller of control assembly 34 to actuate the pair of actuators 132 which, when actuated, cause arm 108 to be vertically raised or lowered with respect to body 22, thereby causing cutting member 100 to be vertically raised or lowered with respect to body 22, as needed. Finally, in one or more illustrative arrangements as examples, the user may also use the remote controller of control assembly 34 to actuate the motor of tilt member 110, which causes the rotating member 152 of tilt member 110 to rotate with respect to body 22, which causes plant engagement member 96, cutting member bracket 98, and cutting member 100 to move angularly (i.e., tilt upward or downward), as needed.

In one or more illustrative arrangements, as examples, in Step 1.4 the user will then assess if system 10 and cutting module 28 are ready to cut. If they are not, the user will repeat Steps 1.2, 1.3, and 1.4 until the proper relative position between cutting module 28 and target vegetation/plant is achieved. If system 10 and cutting module 28 are ready to cut, the user will move on to step 1.5, which is performing a cutting operation on the invasive species and/or target plant using cutting member 100. In one or more illustrative arrangements, as examples, the cutting operation includes utilizing plant engagement member 96, and particularly clamp members 164 and clamp actuators 164 to grasp the invasive species and/or target plant, then cutting module 28 operates to push the blade of cutting member 100 through the invasive species and/or target plant, thereby cutting the invasive species and/or target plant. Finally, in Step 1.6, once the invasive species and/or target plant is cut, the user causes the spraying module 30 to spray a solution on the remains of the invasive species and/or target plant in order to eradicate it.

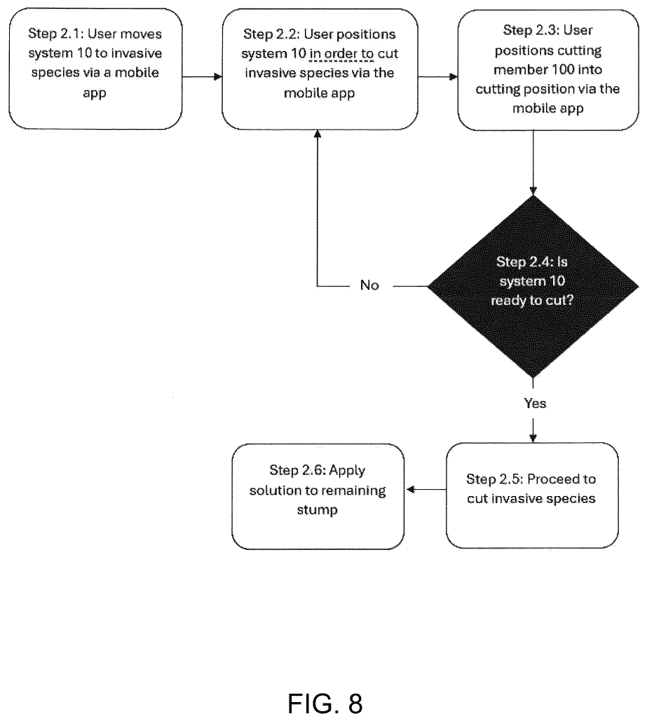

In one or more illustrative arrangements, as examples, the remote controller of control assembly 34 may be a mobile application (or mobile app) used by the user, in which case the steps taken by the user are similar to Steps 1.1 through 1.6, but the user inputs those instructions through a mobile app to perform the steps, as shown in FIG. 8 and Steps 2.1 to 2.6.

### Semi-Autonomous Mode:

In one or more illustrative arrangements, as examples, system 10 may operate in a semi-autonomous mode. As shown in the figures, when system 10 is utilized in a given environment or terrain in the semi-autonomous mode, system 10 follows Steps 3.1 through 3.7, as shown in FIG. 9. In Step 3.1, the optical module 26 uses camera 64 to capture or record images and/or videos of vegetation/plants, and identification system 66 of optical module 26 identifies possible invasive species and/or target plants and shows the potential targets to the user of system 10 via user interface 92, which may be, in the arrangement shown as one example, a mobile app. In Step 3.2, the user views the images and/or videos captured or recorded by camera 64 and chooses which invasive species and/or target plants system 10 should cut first. In this illustrative arrangement, as one example, the positioning system 32 operates to move system 10 into place.

In one or more illustrative arrangements, as examples, in Step 3.3, once system 10 as a whole, is in the proper position, positioning system 32 then moves cutting member 100 to the correct position in order to cut the invasive species and/or target plant. In this illustrative arrangement, as one example, positioning system 32 operates to actuate the actuator of rotating member 102 of arm assembly 94, which causes rotating member 102 to rotate with respect to body 22, which causes arm assembly 94, and subsequently cutting member 100, to move side-to-side, as needed. Additionally or alternatively, positioning system 32 operates to actuate linear actuator 166 to move cutting member bracket 98 from side-to-side, thereby causing cutting member 100 to move side-to-side, as needed.

In one or more illustrative arrangements, as examples, positioning system 32 operates to actuate pair of actuators 132 which, when actuated, cause arm 108 to be vertically raised or lowered, thereby causing cutting member 100 to be vertically raised or lowered, as needed, with respect to body 22. Finally, in one or more illustrative arrangements, as examples, positioning system 32 operates to actuate the motor of tilt member 110, which causes rotating member 152 of tilt member 110 to rotate with respect to body 22, which causes plant engagement member 96, cutting member bracket 98, and cutting member 100 to move angularly (i.e., tilt upward or downward), as needed.

In one or more illustrative arrangements, as examples, in Step 3.4 positioning system 32 determines whether system 10 and cutting module 28 are ready to cut. If they are not, in Step 3.5 positioning system 32 will send a notification to the user via user interface 206 (which may also be user interface 92) stating that the cutting operation cannot be performed. Once the user receives this notification, the user will repeat Step 3.2 and choose which invasive species and/or target plants to cut. After that, positioning system 32 will repeat its part of Step 3.2, as well as 3.3 and 3.4. If system 10 and cutting module 28 are ready to cut, system 10 will move on to step 3.6, which is performing a cutting operation on the invasive species and/or target plant using cutting member 100. In one or more illustrative arrangements, as examples, the cutting operation includes utilizing plant engagement member 96, and particularly clamp members 164 and clamp actuators 164 to grasp the invasive species and/or target plant, then cutting module 28 operates to push the blade of cutting member 100 through the invasive species and/or target plant, thereby cutting the invasive species and/or target plant. Finally, in Step 3.7, once the invasive species and/or target plant is cut, spraying module 30 will spray a solution on the remains of the invasive species and/or target plants in order to eradicate it.

### Fully Autonomous Mode:

In one or more illustrative arrangements, as examples, system 10 may operate in a fully autonomous mode. As shown in the figures, when system 10 is utilized in a given environment or terrain in fully autonomous mode, system 10 follows Steps 4.1 through 4.7, as shown in FIG. 10. In Step 4.1, optical module 26 uses camera 64 to capture or record images and/or videos of vegetation/plants, and the identification system 66 of optical module 26 identifies possible invasive species and/or target plants and chooses which invasive species and/or target plants system 10 should cut first. In this illustrative arrangement, as one example, in Step 4.2 positioning system 32 operates to move system 10 into place.

In one or more illustrative arrangements, as examples, in Step 4.3, once system 10 as a whole, is in the proper position, positioning system 32 then moves cutting member 100 to the correct position in order to cut the invasive species and/or target plant. In this illustrative arrangement, as one example, positioning system 32 operates to actuate the actuator of rotating member 102 of arm assembly 94, which causes rotating member 102 to rotate relative to body 22, which causes arm assembly 94, and subsequently cutting member 100, to move side-to-side, as needed. Additionally or alternatively, positioning system 32 operates to actuate linear actuator 166 to move cutting member bracket 98 from side-to-side, thereby causing cutting member 100 to move side-to-side, as needed.

In one or more illustrative arrangements, as examples, positioning system 32 operates to actuate pair of actuators 132 which, when actuated, cause arm 108 to be vertically raised or lowered with respect to body 22, thereby causing cutting member 100 to be vertically raised or lowered with respect to body 22, as needed. Finally, in one or more illustrative arrangements, as examples, positioning system 32 operates to actuate the motor of tilt member 110, which causes rotating member 152 of tilt member 110 to rotate with respect to body 22, which causes plant engagement member 96, cutting member bracket 98, and cutting member 100 to move angularly (i.e., tilt upward or downward), as needed.

In one or more illustrative arrangements, as examples, in Step 4.4 positioning system 32 determines whether system 10 and cutting module 28 are ready to cut. If they are not, in Step 4.5 positioning system 32 will move system 10 in reverse in order to place the invasive species and/or target plant into the field of view of a camera (e.g., camera 64) or other sensor of positioning system 32 and positioning system 32 will recalculate the proper cutting position. Positioning system 32 will then repeat Steps 4.2, 4.3, and 4.4. Once system 10 and cutting module 28 are ready to cut, system 10 will move on to step 4.6, which is performing a cutting operation on the invasive species and/or target plant using cutting member 100. In one or more illustrative arrangements, as examples, the cutting operation includes utilizing plant engagement member 96, and particularly clamp members 164 and clamp actuators 164 to grasp the invasive species and/or target plant, then cutting module 28 operates to push the blade of cutting member 100 through the invasive species and/or target plant, thereby cutting it. Finally, in Step 4.7, once the invasive species is cut, spraying module 30 will spray a solution on the remains of the invasive species and/or target plant in order to eradicate it.

Though the illustrative arrangements of a system 10 described and disclosed herein may be specifically adapted for use with removal of vegetative invasive species, the scope of the present disclosure is not so limited and may apply to other applications such as removing overgrowth of non-invasive species, providing passage through thickly wooded areas, and/or other applications for removing a target plant/vegetative species without limitation unless otherwise indicated in the following claims.

From the present disclosure, it will be apparent to those or ordinary skill in the art that certain illustrative arrangements of a system 10 as disclosed herein allow approximate positioning of system 10 and cutting module 28 with respect to a target vegetation/plant utilizing drive system 24. Additional axes for proper positioning of cutting member 100 and/or spraying module 30 with respect to a target vegetation/plant while body 22 is stationary with respect to the target vegetation/plant and terrain may be provided by rotating member 102 (having a vertically oriented axis of rotation), arm assembly 94 (having a horizontally oriented axis of rotation about connection member(s) 116), and tilt member 110 (having a horizontally oriented axis of rotation about rotating member 152). Additionally, arm assembly 94 provides linear adjustability of the position of cutting module 28 in a direction parallel to side members 42 of body 22 and linear actuator 166 provides linear adjustability of cutting member 100 in a direction perpendicular to side members 42 of body 22. In this manner, various illustrative arrangements of a system 10 allow fine-tuning of the position of cutting member 100 and/or spraying module 30 in multiple directions and rotational axes even when body 22 is stationary with respect to the target vegetation/plant and terrain. Other arrangements of a system 10 may include adjustability in fewer directions and/or rotational axes or adjustability in more directions and/or rotational axes (e.g., such as a six-axis robotic arm) without limitation unless otherwise indicated the following claims.

Additionally, although illustrative arrangements of a system 10 disclosed and pictured herein may be configured as an unmanned ground vehicle, other illustrative arrangements of a system 10 may be differently configured. For example, in an illustrative arrangement not pictured herein, system 10 may be configured as a humanoid bot, a quadruped bot, a humanoid bot utilizing dual wheels and/or tracks, or any other suitable type of configuration without limitation unless otherwise indicated in the following claims. Additionally, various components of system 10 are described and disclosed herein as having a specific shape and/or geometry. However, the optimal shape and/or geometry for any component of system 10 may vary from one application thereof to the next and is therefor in no way limiting to the scope of the present disclosure unless otherwise indicated in the following claims. In an illustrative arrangement of a system 10, any configuration of components that allows system 10 to identify, cut, and subsequently spray an invasive plant species and/or target plants may be used without limitation unless otherwise indicated in the following claims.

In an illustrative arrangement, it is contemplated that system 10 will be relatively compact in dimensions such that it may traverse an environment with multiple obstacles and/or heavy vegetation with minimal likelihood of becoming stuck and/or otherwise inoperable. Additionally, it is contemplated that in the illustrative arrangement system 10 will not be overly heavy, and may be less than 200 pounds (or less than 150 pounds), such that minimal to no damage to desired vegetation/plants is experienced as system 10 traverses and/or is deployed in a specific environment.

From the above discussion it will be appreciated that system 10 presented herein improves upon the state of the art. Specifically, but without limitation unless otherwise indicated in the following claims, in one or more illustrative arrangements, a robotic modular system 10 is presented which: improves upon the state of the art; is capable of navigating in various types of terrains; is capable of traversing various obstacles; is safe to operate; is relatively easy to build; is relatively friendly to build; can be built relatively quickly and efficiently; is easy to operate; is relatively cost friendly to manufacture; is relatively easy to transport; is aesthetically appealing; is robust; is relatively inexpensive; is not easily susceptible to wear and tear; has a long useful life; is efficient to use and operate.

Having described preferred aspects and embodiments of the various systems, apparatuses, arrangements, and methods of the present disclosure, other features of the present disclosure will undoubtedly occur to those versed in the art, as will numerous modifications and alterations in the embodiments, arrangements, and/or methods as illustrated herein, all of which may be achieved without departing from the spirit and scope of the present disclosure. Accordingly, the embodiments, arrangements, and methods pictured and described herein are for illustrative purposes only, and the scope of the present disclosure extends to all embodiments, arrangements, and/or methods for providing the various benefits and/or features of the present disclosure unless so indicated in the following claims.

While the embodiments, arrangements, and methods of the present disclosure have been described in connection with preferred embodiments, arrangements, and methods and specific examples, it is not intended that the scope be limited to the particular embodiments and/or arrangements set forth, as the embodiments and/or arrangements herein are intended in all respects to be illustrative rather than restrictive unless otherwise indicated in the following claims. Accordingly, the embodiments, arrangements, and methods pictured and described herein are in no way limiting to the scope of the present disclosure unless so stated in the following claims.

Although several figures are drawn to accurate scale, any dimensions provided herein are for illustrative purposes only and in no way limit the scope of the present disclosure unless so indicated in the following claims. It should be noted that the embodiments, arrangements, and methods described herein are not limited to the specific illustrative examples pictured and described herein, but rather the scope of the inventive features according to the present disclosure is defined by the claims herein. Modifications and alterations from the described embodiments, arrangements, and methods will occur to those skilled in the art without departure from the spirit and scope of the present disclosure.

Any of the various features, components, functionalities, advantages, aspects, configurations, process steps, methods, method steps, etc., may be used alone or in combination with one another depending on the compatibility of the features, components, functionalities, advantages, aspects, configurations, process steps, methods, method steps, etc. Accordingly, a nearly infinite number of variations of the present disclosure exist. Modifications and/or substitutions of one features, components, functionalities, advantages, aspects, configurations, process steps, methods, method steps, etc. for another in no way limit the scope of the present disclosure unless so indicated in the following claims.

It is understood that the present disclosure extends to all alternative combinations of one or more of the individual features and/or components mentioned, evident from the text and/or drawings, and/or inherently disclosed. All of these different combinations constitute various alternative aspects of the present disclosure and/or components thereof. The embodiments described herein explain the best modes known for practicing the inventive features of the present disclosure and will enable others skilled in the art to utilize the same. The claims are to be construed to include alternative embodiments to the extent permitted by the prior art.

Unless otherwise expressly stated in the claims, it is in no way intended that any process or method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including but not limited to: matters of logic with respect to arrangement of steps or operational flow; plain meaning derived from grammatical organization or punctuation; the number or type of embodiments described in the specification.

What is claimed:

1. A robotic modular system configured to remove a vegetative species, the system comprising:
an optical module;
a cutting module;
wherein the optical module is configured to identify a target plant of the vegetation species;
wherein the system is configured to traverse a natural environment to a position near the target plant;
wherein the system is configured to position the cutting module adjacent the target plant in order to perform a cutting operation, and wherein the cutting module performs the cutting operation on the target plant.

2. The system of claim 1, and wherein after the cutting module cuts the target plant, the spraying module is configured to spray a remaining portion of the target plant with a solution.

3. The system of claim 1, wherein a user controls the system via a remote controller.

4. The system of claim 1, wherein a user controls the system via a mobile application.

5. The system of claim 1, wherein the system is controlled semi-autonomously.

6. The system of claim 1, wherein the system is autonomous.

7. The system of claim 1, wherein the cutting module includes a blade.

8. The system of claim 1, wherein the cutting module includes a laser cutter.

9. The system of claim 1, wherein the cutting module includes a plasma cutter.

10. The system of claim 1, further comprising a spraying module;
wherein the spraying module is configured to spray a herbicide.

11. The system of claim 1, wherein the optical module matches a leaf of the vegetative species to a leaf of the target plant to identify the target plant.

12. The system of claim 1, wherein the optical module matches a bark pattern of the vegetative species to a bark pattern of the target plant to identify the target plant.

13. A robotic modular system configured to remove a target vegetative species, the system comprising:
an optical module;
a cutting module;
wherein the system is configured to autonomously traverse a specific area;
wherein the optical module is configured to view a plurality of characteristics belonging to a plurality of vegetative species;
wherein the system identifies each characteristic in the plurality of characteristics using a database containing a second plurality of characteristics;
wherein if a characteristic in the plurality of characteristics is identified as the target vegetative species, the system sends a notification to a user of the system and the user is prompted to confirm the characteristic belongs to the target vegetative species;
wherein if the user confirms the characteristic belongs to the target vegetative species, the system autonomously positions the cutting module adjacent a target plant of the target vegetative species and the cutting module performs a cutting operation on the target plant.

14. The system of claim 13, further comprising a spraying module, wherein after the cutting module cuts the target plant, the spraying module is configured to spray a remaining portion of the target plant.

15. The system of claim 13, wherein the plurality of characteristics includes a shape and a color of a plurality of leaves.

16. The system of claim 13, wherein the plurality of characteristics includes a pattern and a color of a plurality of types of bark.

17. The system of claim 13, wherein the cutting module includes a blade.

18. The system of claim 13, wherein the cutting module includes a laser cutter.

19. The system of claim 13, wherein the cutting module includes a plasma cutter.

20. The system of claim 13, further comprising a spraying module;
wherein the spraying module is configured to spray a herbicide.

21. The system of claim 13, further comprising a spraying module;
wherein the spraying module is configured to spray a herbicide used in a hack-and-squirt method of removing invasive species.

22. A robotic modular system configured to remove invasive species, the system comprising:
an optical module;
a cutting module;
a spraying module;
wherein the system is configured to autonomously traverse a specific area;
wherein the optical module is configured to view a plurality of leaves belonging to a plurality of vegetative species;
wherein the system identifies each leaf in the plurality of leaves using a database containing images of a second plurality of leaves;
wherein in response to identifying a leaf in the plurality of leaves as a target invasive species, the system autonomously positions the cutting module adjacent a target plant of the target vegetative species and the cutting module performs a cutting operation on the target plant.

23. The system of claim 22, further comprising a spraying module, wherein after the cutting module cuts the target plant, the spraying module is configured to spray a remaining portion of the target plant.

24. The system of claim 22, wherein the spraying module is configured to spray a herbicide.

25. A robotic modular system configured to remove invasive species, the system comprising:
a body, wherein the body is engaged with a drive system configured to provide a motive power and directionality of the motive power to the body;
an optical module operatively engaged with the body, wherein the optical module includes a camera, wherein the camera records at least one image of a plant;
a cutting module operatively engaged with the body, wherein the cutting module is configured to move at horizontally and vertically with respect to the body, wherein the cutting module is configured to rotate about a vertical axis with respect to the body, and wherein the cutting module is configured rotate about a horizontal axis with respect to the body; and,
wherein the system is configured to traverse a natural environment using the drive system, identify a target plant using the optical module, and cut the target plant using the cutting module.

26. The system of claim 25, wherein the system further comprises a spraying module operatively engaged with the body, wherein the spraying module sprays a remaining portion of the target plant after the target plant is cut.

27. The system of claim 25, wherein the drive system further comprises a rocker-bogie suspension system.

28. The system of claim 25, wherein the cutting module further comprises an arm assembly that is moveable with respect to the body in a linear direction and a plant engagement member operably engaged with a first end of the arm assembly.

29. A method for removing a vegetative species using a robotic modular system, the method comprising:
allowing the robotic modular system to traverse a specific area using a drive system of the robotic modular system;
using an optical module of the robotic modular system to record a plurality of images of a plurality of vegetative species within the specific area;
identifying a potential target plant of the vegetative species by comparing the plurality of images of the plurality of vegetative species within the specific area to a second plurality of images of a second plurality of vegetative species contained in a database;
positioning a cutting module of the robotic modular system adjacent the potential target; and,
cutting the potential target plant with the cutting module.

30. The method according to claim 29, wherein the method further comprises transmitting an image of the potential target plant to a user and prompting the user to confirm or reject the potential target plant based on the image.

31. The method according to claim 29, wherein the method further comprises spraying a remaining portion of the potential target plant after cutting the potential target plant using a spraying module of the robotic modular system.
